(19) United States
(12) Patent Application Publication
(10) Pub. No.: US 2026/0068911 A1
(43) Pub. Date: Mar. 12, 2026

(54) EQUIPMENT FOR REDUCING SUGAR IN FRUIT JUICE, METHOD FOR REDUCING SUGAR IN FRUIT JUICE, SUGAR-REDUCED FRUIT JUICE AND RELATED APPLICATIONS

(71) Applicant: GUANGZHOU WANGLAOJI GREAT HEALTH INDUSTRY CO., LTD., Guangzhou (CN)

(72) Inventors: Yi LIU, Guangzhou (CN); Hui ZHANG, Guangzhou (CN); Yu WANG, Guangzhou (CN); Fengyuan ZHANG, Guangzhou (CN); Mingqing KUANG, Guangzhou (CN); Guihua LUAN, Guangzhou (CN); Yanfang WANG, Guangzhou (CN); Bing YAN, Guangzhou (CN)

(73) Assignee: GUANGZHOU WANGLAOJI GREAT HEALTH INDUSTRY CO., LTD., Guangzhou (CN)

(21) Appl. No.: 19/295,462

(22) Filed: Aug. 8, 2025

(30) Foreign Application Priority Data
Sep. 9, 2024 (CN) 202411252396.9

(51) Int. Cl. A23L 2/84

(52) U.S. Cl. CPC A23L 2/84

(57) ABSTRACT

The present application provides an equipment for reducing sugar in fruit juice, a method for reducing sugar in fruit juice, a sugar-reduced fruit juice and related applications. The equipment for reducing sugar in fruit juice comprises a frame, a magnetic field generating device and a hollow fermentation tank. The method for reducing sugar in fruit juice comprises preparing a magnetic carrier; immobilizing an enzyme on the magnetic carrier to obtain a magnetic immobilized enzyme; and reducing sugar in fruit juice by an equipment for reducing sugar in fruit juice described above and the magnetic immobilized enzyme. The sugar-reduced fruit juice made according to the present application can be better applied in maintaining body shape and/or preparing products for preventing diseases.

This application claims priority to Chinese Patent Application No. 202411252396.9, titled “EQUIPMENT FOR REDUCING SUGAR IN FRUIT JUICE, METHOD FOR REDUCING SUGAR IN FRUIT JUICE, SUGAR-REDUCED FRUIT JUICE AND RELATED APPLICATIONS”, filed on Sep. 9, 2024 with the China National Intellectual Property Administration, which is incorporated herein by reference in entirety.

### FIELD

The application relates to the technical field of food engineering, in particular to an equipment for reducing sugar in fruit juice, a method for reducing sugar in fruit juice, a sugar-reduced fruit juice and related applications.

### BACKGROUND

Juice is a kind of drink obtained from fresh fruit by physical methods such as squeezing, centrifugation and extraction, which retains most of the nutritional components in the fruit, such as vitamins, minerals, sugar and pectin in dietary fiber, and fruit juices made from different fruits have different tastes. In the related art, when reducing sugar in fruit juice, enzymes can be added to the fruit juice to decompose sugar (such as sucrose, glucose, etc.) in the fruit juice into other substances by the enzymolysis reaction, so as to realize the sugar reduction in fruit juice. Usually, the enzyme used in the enzymolysis reaction is either free enzyme or immobilized enzyme (for example, fructosyltransferase is immobilized on sodium alginate gel carrier by embedding method). When the enzyme used in the enzymolysis reaction is free enzyme, it is necessary to heat the fruit juice after the enzymolysis reaction to realize the inactivation of the free enzyme by using high temperature, which not only increases the sugar reduction process of fruit juice, but also causes the loss of nutritional components in fruit juice and affects the taste of fruit juice. When the enzyme used in the enzymolysis reaction is immobilized enzyme, it is necessary to separate the immobilized enzyme from the fruit juice by centrifugation or filtration after the enzymolysis reaction. However, because the fruit juice contains a small amount of insoluble substances, and these insoluble substances will be mixed with the immobilized enzyme, these insoluble substances are easy to adhere to the immobilized enzyme after deposition, thus reducing the reuse rate of the immobilized enzyme.

### SUMMARY

The application provides an equipment for reducing sugar in fruit juice, a method for reducing sugar in fruit juice, a sugar-reduced fruit juice and related applications. The application aims to solve the problems in related technologies that when enzymatic hydrolysis is used to reduce sugar in fruit juice, the nutritional components in the fruit juice are severely lost and the reuse rate of enzymes is relatively low.

In order to solve the above-mentioned disadvantages in related technologies, a first aspect of the application provides an equipment for reducing sugar in fruit juice, which comprises a frame, a magnetic field generating device and a hollow fermentation tank, wherein the magnetic field generating device and the fermentation tank are arranged on the frame and spaced apart from each other, and the fermentation tank is provided with a liquid inlet and a liquid outlet communicated with an inside of the fermentation tank. Specifically, the liquid inlet is configured to introduce the fruit juice and the magnetic immobilized enzyme into the fermentation tank to reduce sugar in the fruit juice by utilizing an enzymolysis reaction of the magnetic immobilized enzyme in the fruit juice; the magnetic field generating device is configured to generate a magnetic field which penetrates into the fermentation tank after the enzymolysis reaction is completed to adsorb the magnetic immobilized enzyme onto the inner wall of the fermentation tank; and the liquid outlet is configured to discharge the fruit juice in the fermentation tank after the magnetic field generating device adsorbs the magnetic immobilized enzyme onto the inner wall of the fermentation tank. Further, the equipment for reducing sugar in fruit juice also comprises a controller arranged on the frame and communicatively connected to the magnetic field generating device, and the controller is configured to control the magnetic field generating device to generate a magnetic field which penetrates into the fermentation tank after the enzymolysis reaction is completed.

In some embodiments, the magnetic field generating device comprises an electromagnetic device and a power supply arranged on the frame, wherein the electromagnetic device is spaced apart from the fermentation tank and electrically connected to the power supply, the power supply is communicatively connected to a controller, and the controller is specifically configured to control the power supply to power the electromagnetic device after the enzymolysis reaction is completed, so that the electromagnetic device generates a magnetic field which penetrates into the fermentation tank. In one embodiment, the electromagnetic device comprises an annular electromagnet surrounding the fermentation tank. In another embodiment, the electromagnetic device comprises at least one electromagnet; wherein, when the electromagnetic device comprises two electromagnets, the two electromagnets are located on two opposite sides of the fermentation tank respectively; and when the electromagnetic device comprises more than two electromagnets, the plurality of electromagnets are arranged around the fermentation tank and any two adjacent electromagnets are spaced apart from each other.

In some embodiments, the magnetic field generating device comprises a magnetic attraction device, a lifting device and a magnetic shielding plate, wherein the magnetic attraction device is arranged on the frame and spaced apart from the fermentation tank, the lifting device is arranged on the frame and located between the magnetic attraction device and the fermentation tank, the magnetic shielding plate is arranged on the lifting device and drivingly connected to the lifting device, the lifting device is communicatively connected to the controller, and the controller is specifically configured to control the lifting device to drive the magnetic shielding plate to rise between the magnetic attraction device and the fermentation tank before the enzymolysis reaction starts, so as to prevent the magnetic field generated by the magnetic attraction device from penetrating into the fermentation tank, so that the magnetic immobilized enzyme is dispersed in the fruit juice; and to control the lifting device to drive the magnetic shielding plate to withdraw from between the magnetic attraction device and the fermentation tank after the enzymolysis reaction is completed, so that the magnetic field generated by the magnetic attraction device penetrates into the fermentation tank. In one embodiment, the magnetic attraction device comprises an annular magnet surrounding the fermentation tank. In another embodiment, the magnetic attraction device comprises at least one magnet; wherein, when the electromagnetic device comprises two electromagnets, the two magnets are located on two opposite sides of the fermentation tank respectively; and when the magnetic attraction device comprises more than two magnets, the plurality of magnets are arranged around the fermentation tank and any two adjacent magnets are spaced apart from each other.

In some embodiments, the equipment for reducing sugar in fruit juice further comprises a temperature detector and a heating device which are communicatively connected to the controller respectively, wherein the heating device is arranged on the frame and is in contact with the outer wall of the fermentation tank, and the temperature detector is arranged on the inner wall of the fermentation tank and configured to be immersed in the fruit juice. Specifically, the heating device is configured to heat the fruit juice before the enzymolysis reaction is completed; the temperature detector is configured to detect the temperature of the fruit juice in real time and transmit the temperature of the fruit juice to the controller before the enzymolysis reaction is completed; and the controller is further configured to judge whether the temperature of the fruit juice is within the preset temperature range, and if not, to control the heating device to adjust the heating amount for heating the fruit juice, so that the temperature of the fruit juice is within the preset temperature range.

In one embodiment, the heating device comprises a heating jacket and a power source communicatively connected to the controller, wherein the heating jacket is sleeved on the outer wall of the fermentation tank, and the power source is arranged on the frame and electrically connected to the heating jacket. Specifically, the power source is configured to deliver a heating current to the heating jacket to heat the heating jacket; the heating jacket is configured to heat the fruit juice through the heat emitted by itself; and the controller is specifically configured to control the power source to adjust the magnitude of the heating current when the temperature of the fruit juice is not within the preset temperature range, so as to adjust the heating amount of the heating jacket for heating the fruit juice, so that the temperature of the fruit juice is within the preset temperature range. In this embodiment, the heating jacket comprises a heating element, a connecting terminal, an insulating layer and an inner layer and an outer layer that are opposite to each other, wherein the inner layer is configured to contact with the outer wall of the fermentation tank, the insulating layer is arranged between the inner layer and the outer layer, the heating element is arranged between the insulating layer and the inner layer, the connecting terminal is arranged on the outer layer, and the heating element is electrically connected to the power source through the connecting terminal. Specifically, the connecting terminal is configured to deliver the heating current provided by the power source to the heating element to heat the heating element; and the heating element is configured to heat the fruit juice through the heat emitted by itself.

In one embodiment, the heating device comprises a water storage jacket and a circulating water heating assembly, wherein the water storage jacket is sleeved on the outer wall of the fermentation tank, the circulating water heating assembly is arranged on the frame and connected to the water storage jacket, and the circulating water heating assembly is communicatively connected to the controller. Specifically, the circulating water heating assembly is configured to circulate the heating water into the water storage jacket and recycle the heating water in the water storage jacket to heat the water storage jacket; the water storage jacket is configured to heat the fruit juice through the heat emitted by itself; and the controller is specifically configured to control the circulating water heating assembly to adjust the temperature of heating water when the temperature of the fruit juice is not within the preset temperature range, so as to adjust the heating amount of the water storage jacket for heating the fruit juice, so that the temperature of the fruit juice is within the preset temperature range.

In this embodiment, the circulating water heating assembly comprises a heater, a water tank, a circulating water pump, a water inlet pipe and a water return pipe, wherein the heater, the water tank and the circulating water pump are all arranged on the frame, the heater is in contact with the outer wall of the water tank, one end of the water inlet pipe is arranged in the water storage jacket, and the opposite end is communicated with the water tank through the circulating water pump, one end of the water return pipe is arranged in the water storage jacket, and the opposite end is communicated with the water tank through the circulating water pump; and the heater and the circulating water pump are communicatively connected to the controller respectively. Specifically, the heater is configured to heat the heating water stored in the water tank; the circulating water pump is configured to circulate the heating water in the water tank into the water storage jacket through the water inlet pipe under the control of the controller, and to recycle the heating water in the water storage jacket into the water tank through the water return pipe to heat the water storage jacket; and the controller is specifically configured to control the heater to adjust the heating amount for heating the heating water when the temperature of the fruit juice is not within the preset temperature range, so as to adjust the heating amount of the water storage jacket for heating the fruit juice, so that the temperature of the fruit juice is within the preset temperature range.

In some embodiments, the equipment for reducing sugar in fruit juice further comprises a dissolved oxygen detector, a compressed air device and an air delivery pipe, wherein the dissolved oxygen detector and the compressed air device are communicatively connected to the controller respectively, the compressed air device is arranged on the frame, the dissolved oxygen detector is arranged on the inner wall of the fermentation tank and configured to be immersed in the fruit juice, the air delivery pipe is provided with an air inlet end and an air outlet end that are opposite to each other, the air inlet end is connected to the compressed air device, and the air outlet end is arranged in the fermentation tank and configured to be inserted into the fruit juice. Specifically, the compressed air device is configured to generate normal-temperature compressed air and deliver the normal-temperature compressed air to the fruit juice through the air delivery pipe before the enzymolysis reaction is completed; the dissolved oxygen detector is configured to detect the dissolved oxygen of the fruit juice in real time and transmit the dissolved oxygen of the fruit juice to the controller before the enzymolysis reaction is completed; and the controller is further configured to judge whether the dissolved oxygen of the fruit juice is within the preset dissolved oxygen range, and if not, to control the compressed air device to adjust the delivery amount of the normal-temperature compressed air to the fruit juice to adjust the dissolved oxygen of the fruit juice, so that the dissolved oxygen of the fruit juice is within the preset dissolved oxygen range.

In one embodiment, the compressed air device comprises a driving motor, a compressor, an air filter element, a cooler and an air storage tank which are arranged on a frame, wherein the air filter element, the compressor, the cooler and the air storage tank are connected in sequence, the air storage tank is connected to the air inlet end of the air delivery pipe through a flow control valve, the driving motor is drivingly connected to the compressor, and the driving motor and the flow control valve are communicatively connected to the controller respectively. Specifically, the driving motor is configured to drive the compressor under the control of the controller; the air filter element is configured to filter the air entering the compressor; the compressor is configured to compress the air and correspondingly obtain a high-temperature compressed air; the cooler is configured to cool high-temperature compressed air and correspondingly obtain a normal-temperature compressed air; the gas storage tank is configured to store he normal-temperature compressed air; the flow control valve is configured to deliver the normal-temperature compressed air in the gas storage tank to the fruit juice through the gas delivery pipe; and the controller is specifically configured to control the flow control valve to adjust its opening degree when the dissolved oxygen of the fruit juice is not within the preset dissolved oxygen range, so as to adjust the delivery amount of the normal-temperature compressed air to the fruit juice, so that the dissolved oxygen of the fruit juice is within the preset dissolved oxygen range.

In some embodiments, the equipment for reducing sugar in fruit juice further comprises a pH detector, a pH adjusting device and a liquid delivery tube, wherein the pH detector and the pH adjusting device are communicatively connected to the controller respectively, the pH adjusting device is arranged on the frame; the pH detector is arranged on the inner wall of the fermentation tank and configured to be immersed into the fruit juice, and the liquid delivery tube is provided with a liquid inlet end and a liquid outlet end that are opposite to each other; the liquid inlet end is connected to the pH adjusting device, and the liquid outlet end is arranged in the fermentation tank and configured to be inserted into the fruit juice. Specifically, the pH adjusting device is configured to inject an acidic solution and/or an alkaline solution into the fruit juice through the liquid delivery tube before the enzymolysis reaction is completed; the pH detector is configured to detect the pH of the fruit juice in real time and transmit the pH of the fruit juice to the controller before the enzymolysis reaction is completed; and the controller is further configured to judge whether the pH of the fruit juice is within the preset pH range, and if not, to control the pH adjusting device to adjust the injection amount of the acidic solution and/or the alkaline solution into the fruit juice, so that the pH of the fruit juice is within the preset pH range.

In one embodiment, the liquid delivery tube comprises an acidic liquid delivery tube and an alkaline liquid delivery tube, and the pH adjusting device comprises an acidic liquid storage tank, an alkaline liquid storage tank and a metering pump arranged on the frame, wherein the metering pump is communicatively connected to a controller, the acidic liquid storage tank is configured to store the acidic solution, the alkaline liquid storage tank is configured to store the alkaline solution, a liquid outlet end of the acidic liquid delivery tube is arranged in a fermentation tank and is configured to be inserted into the fruit juice, a liquid inlet end of the acidic liquid delivery tube is communicated with the acidic liquid storage tank through the metering pump, a liquid outlet end of the alkaline liquid delivery tube is arranged in the fermentation tank and is configured to be inserted into fruit juice, and a liquid inlet end of the alkaline liquid delivery tube is communicated with the alkaline liquid storage tank through the metering pump. Specifically, the metering pump configured to pump the acidic solution from the acidic liquid storage tank and inject it into the fruit juice through the acidic liquid delivery pipe, and/or to pump the alkaline solution from the alkaline liquid storage tank and inject it into the fruit juice through the alkaline liquid delivery pipe; and the controller is specifically configured to control the metering pump to adjust the pumping amount of the acidic solution and/or the alkaline solution when the pH of the fruit juice is not within the preset pH range, so as to adjust the injection amount of the acidic solution and/or the alkaline solution into the fruit juice, so that the pH of the fruit juice is within the preset pH range.

In some embodiments, the equipment for reducing sugar in fruit juice further comprises a stirring device arranged on the inner wall of the fermentation tank and communicatively connected to the controller, wherein the controller is further configured to control the stirring device to stir the fruit juice before the enzymolysis reaction is completed. In one embodiment, the stirring device comprises a stirring blade and a stirring motor communicatively connected to the controller, wherein the stirring motor is arranged on the inner wall of the fermentation tank and drivingly connected to the stirring blade, and the controller is specifically configured to control the stirring motor to drive the stirring blade to rotate before the enzymolysis reaction is completed, so as to stir the fruit juice through the rotation of the stirring blade.

In some embodiments, equipment for reducing sugar in fruit juice further comprises a pressure detector, an electric actuator and an exhaust valve, wherein the fermentation tank is further provided with an exhaust port communicated with the inside of the alkaline liquid delivery tube, the exhaust valve is arranged in the exhaust port, the electric actuator is arranged on the exhaust valve and drivingly connected to the exhaust valve, the pressure detector is arranged on the inner wall of the fermentation tank, and the pressure detector and the electric actuator are communicatively connected with the controller respectively. Specifically, the electric actuator is configured to open or close the exhaust valve; the pressure detector is configured to detect the pressure in the fermentation tank in real time and transmit the pressure in the fermentation tank to the controller before the enzymolysis reaction is completed; and the controller is further configured to judge whether the pressure in the fermentation tank exceeds the preset safe pressure range, and when the pressure exceeds the safe pressure range, to control the electric actuator to open the exhaust valve to exhaust the gas in the fermentation tank, so that the pressure in the fermentation tank returns to the safe pressure range, and to control the electric actuator to close the exhaust valve after the pressure in the fermentation tank returns to the safe pressure range.

In some embodiments, the fermentation tank is provided with an upper end and a lower end that are opposite to each other, wherein the liquid inlet is located on the upper end and the liquid outlet is located on the lower end, and the position of the liquid outlet is lower than that of the magnetic field generating device.

A second aspect of the application provides a method for reducing sugar in fruit juice, which comprises: preparing a magnetic carrier; immobilizing an enzyme on the magnetic carrier to obtain a magnetic immobilized enzyme; reducing sugar in fruit juice by magnetic immobilized enzyme and equipment for reducing sugar in fruit juice; wherein, the used equipment for reducing sugar in fruit juice is the equipment for reducing sugar in fruit juice mentioned in the first aspect of the present application.

In some embodiments, the step of preparing the magnetic carrier comprises: dissolving ferric chloride hexahydrate and ferrous chloride tetrahydrate in water to obtain a first mixed solution; adding chitosan into the first mixed solution, and stirring to obtain a second mixed solution; adding sodium hydroxide solution into the second mixed solution, heating and stirring to obtain a third mixed solution, cooling the third mixed solution, and adjusting the pH value of the third mixed solution; adding glutaraldehyde solution into the third mixed solution, and heating and stirring to obtain a fourth mixed solution in which the magnetic carrier is dispersed; and absorbing out the magnetic carrier in the fourth mixed solution with a magnet, and dispersing the magnetic carrier in a boric acid solution to obtain a magnetic carrier dispersion.

In some embodiments, the step of immobilizing the enzyme on the magnetic carrier to obtain the magnetic immobilized enzyme comprises: adding an enzyme solution into the magnetic carrier dispersion, and stirring to obtain a fifth mixed solution; and adding glutaraldehyde solution into the fifth mixed solution, and heating and stirring to immobilize the enzyme in the enzyme solution on the magnetic carrier to form the magnetic immobilized enzyme.

In some embodiments, the step of reducing sugar in fruit juice by the magnetic immobilized enzyme and the equipment for reducing sugar in fruit juice comprises: introducing the fruit juice and the magnetic immobilized enzyme into the fermentation tank through the liquid inlet to reduce sugar in the fruit juice by utilizing the enzymolysis reaction of the magnetic immobilized enzyme in fruit juice; after the enzymolysis reaction is completed, the magnetic field generating device generating the magnetic field, which penetrates into the fermentation tank, to adsorb the magnetic immobilized enzyme on the inner wall of the fermentation tank; and discharging the fruit juice in the fermentation tank through the liquid outlet.

A third aspect of the application provides a sugar-reduced fruit juice, which is made by the equipment for reducing sugar in fruit juice mentioned in the first aspect of the present application or by the method for reducing sugar in fruit juice mentioned in the second aspect of the present application.

A fourth aspect of the present application provides use of sugar-reduced fruit juice in maintaining body shape and/or preparing products for preventing diseases, wherein the sugar-reduced fruit juice is the sugar-reduced fruit juice mentioned in the third aspect of the present application.

As for the equipment for reducing sugar in fruit juice and the method for reducing sugar in fruit juice using the equipment for reducing sugar in fruit juice mentioned in the present application, the fruit juice and the magnetic immobilized enzyme are introduced into the fermentation tank, and the magnetic field generating device is controlled not to generate a magnetic field which penetrates into the fermentation tank, so that the magnetic immobilized enzyme in the fermentation tank is dispersed in the fruit juice, and the magnetic immobilized enzyme dispersed in the fruit juice will undergo enzymolysis reaction, that is, the sugar in the fruit juice is decomposed into other substances, thereby realizing the reduction of sugar in fruit juice. As time elapses, after the enzymolysis reaction is completed, the magnetic field generating device can be controlled to generate a magnetic field which penetrates into the fermentation tank, so that the magnetic immobilized enzyme in the fermentation tank can be adsorbed on the inner wall of the fermentation tank by the magnetic field generating device, and then the fruit juice in the fermentation tank can be discharged to obtain sugar-reduced fruit juice. During the process of discharging the fruit juice, the magnetic field generating device will keep adsorbing the magnetic immobilized enzyme on the inner wall of the fermentation tank, so that the magnetic immobilized enzyme in the fermentation tank will not be discharged from the fermentation tank together with the fruit juice. It can be seen that, in the present application, the magnetic immobilized enzyme is used to reduce sugar in the fruit juice, and it is not necessary to use high temperature to inactivate enzymes as in traditional solutions, so that the sugar reduction process of the fruit juice is simplified, the sugar reduction efficiency is improved, and the nutritional components, flavor and color of the fruit juice can be better retained. In the present application, when the fruit juice is discharged from the fermentation tank, the magnetic field generating device is used to adsorb the magnetic immobilized enzyme to separate the magnetic immobilized enzyme from the fruit juice. Unlike traditional solutions that rely on centrifugation or filtration for separation, this method enables faster separation of the magnetic immobilized enzyme from the fruit juice. It can also prevent insoluble substances in the fruit juice from adhering to the immobilized enzymes, thereby improving the reuse rate of the immobilized enzyme. That is to say, the sugar-reduced fruit juice produced by the present application has higher nutritional components, good flavor and color, and can be well applied in maintaining body shape and/or preparing products for preventing diseases.

### BRIEF DESCRIPTION OF DRAWINGS

In order to describe the technical solutions in related technology or in the embodiments of the present application more clearly, the drawings used in describing the related technology or the embodiments of the present application will be briefly introduced hereinafter. Obviously, the drawings in the following description are only some embodiments of the present application, but not all embodiments, and those skilled in the art can obtain other drawings based on these drawings without creative efforts.

FIG. 1 is a schematic structural diagram of the equipment for reducing sugar in fruit juice provided by an embodiment of the present application;

FIG. 2 is a schematic flowchart of the method for reducing sugar in fruit juice provided by an embodiment of the present application;

FIG. 3 is a schematic flowchart of S201 in FIG. 2 provided by an embodiment of the present application;

FIG. 4 is a schematic flowchart of S202 in FIG. 2 provided by an embodiment of the present application;

FIG. 5 is a schematic flowchart of S203 in FIG. 2 provided by an embodiment of the present application;

FIG. 6 is a test result diagram of sugar-reduced Rosa Roxburghii juice provided by an embodiment of the application for scavenging DPPH free radicals, ABTS free radicals and hydroxyl free radicals;

FIG. 7 is a test result diagram of the influence of sugar-reduced Rosa Roxburghii juice provided by an embodiment of the present application on cell viability;

FIG. 8 is a test result diagram of blood glucose concentration of mice in experimental group and control group provided by an embodiment of the present application; and

FIG. 9 is a test result diagram of sugar tolerance of mice in experimental group and control group provided by an embodiment of the present application.

The reference numbers in each of the above drawings represent, respectively:
100—magnetic attraction device, 200—magnetic shielding plate, 300—fermentation tank, 400—compressed air device, 500—gas delivery pipe, 600—stirring device, 310—liquid inlet, 320—liquid outlet and 330—exhaust port.

### DETAILED DESCRIPTION

In the related art, when reducing sugar in fruit juice by enzymolysis reaction, the used enzyme is either free enzyme or immobilized enzyme. When the enzyme used in the enzymolysis reaction is free enzyme, it is necessary to heat the fruit juice after the enzymolysis reaction to realize the inactivation of the free enzyme by high temperature, which not only increases the sugar reduction process of fruit juice, but also causes the loss of nutritional components in fruit juice and affects the color and taste of fruit juice. When the enzyme used in the enzymolysis reaction is immobilized enzyme, it is necessary to separate the immobilized enzyme from the fruit juice by centrifugation or filtration after the enzymolysis reaction. However, because the fruit juice contains a small amount of insoluble substances, and these insoluble substances will be mixed with the immobilized enzyme, and these insoluble substances are easy to adhere to the immobilized enzyme after centrifugation or filtration, thus reducing the reuse rate of the immobilized enzyme.

In view of this, in the following embodiments, the present application provides an equipment for reducing sugar in fruit juice and a method for reducing sugar in fruit juice using the same. Reducing sugar in fruit juice by using this equipment for reducing sugar in fruit juice and the corresponding method for reducing sugar in fruit juice has the following advantages: it is not necessary to inactivate enzymes using high temperature as in traditional solutions, and it simplifies the sugar reduction process of the fruit juice and improves the sugar reduction efficiency; it can well retain the nutritional components in the fruit juice and the flavor and color of the fruit juice; it can quickly separate enzyme from fruit juice, which avoids insoluble substances in fruit juice from adhering to enzyme and improves the reuse rate of enzyme.

Hereinafter, the present application will be described clearly and completely in conjunction with the embodiments of the present application and the accompanying drawings to make the purpose, technical solutions and advantages of the present application more obvious and easy to understand, wherein the same or similar reference numerals represent the same or similar members or members having the same or similar functions throughout the description. It should be understood that various embodiment of the present application described below are only used to explain the present application, and are not used to limit the present application, that is, all other embodiments obtained by ordinary people in the art based on various embodiments of the present application without creative work belong to the protection scope of the present application. In addition, the technical features involved in various embodiments of the present application described below can be combined with each other as long as they do not conflict with each other.

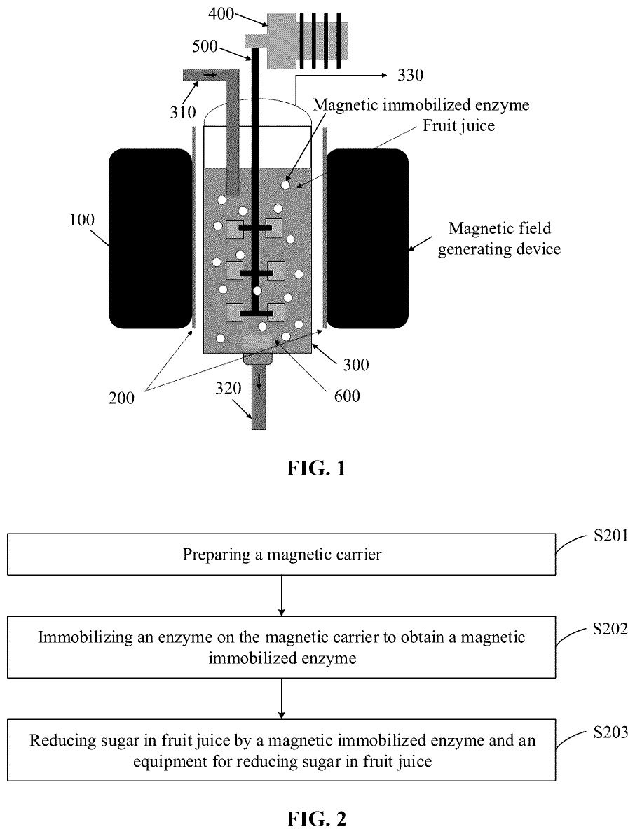

Please refer to FIG. 1, which is a schematic structural diagram of the equipment for reducing sugar in fruit juice. The equipment for reducing sugar in fruit juice is provided according to the embodiment, which comprises a frame (not shown in the figure), a magnetic field generating device and a hollow fermentation tank 300, wherein the magnetic field generating device and the fermentation tank 300 are arranged on the frame and spaced apart from each other, and the fermentation tank 300 is provided with a liquid inlet 310 and a liquid outlet 320 which are communicated with an inside of the fermentation tank, and the fermentation tank 300 is further provided with an upper end and a lower end that are opposite to each other, and the liquid inlet 310 is opened at the upper end of the fermentation tank 300, and the liquid outlet 320 is opened at the lower end of the fermentation tank 300. Specifically, the liquid inlet 310 is configured to introduce the fruit juice and the magnetic immobilized enzyme into the fermentation tank 300, to reduce sugar in the fruit juice by utilizing the enzymatic hydrolysis reaction of the magnetic immobilized enzyme in the fruit juice; the magnetic field generating device is not only configured to not generate a magnetic field which penetrates into the fermentation tank 300 before the enzymolysis reaction is started, so that the magnetic immobilized enzyme in the fermentation tank 300 is dispersed in the fruit juice, but also configured to generate a magnetic field which penetrates into the fermentation tank 300 after the enzymolysis reaction is completed to adsorb the magnetic immobilized enzyme on the inner wall of the fermentation tank 300; and the liquid outlet 320 is configured to discharge the fruit juice in the fermentation tank 300 after the magnetic field generating device adsorb the magnetic immobilized enzyme onto the inner wall of the fermentation tank 300. Furthermore, in the process of reducing sugar in fruit juice, the sugar content of fruit juice can be detected by high performance liquid chromatography (HPLC), and compared with the sugar content before the enzymatic hydrolysis, so as to determine the data of reducing sugar in fruit juice. In an embodiment, the mass-volume ratio of magnetic immobilized enzyme to fruit juice in the fermentation tank 300 is 0.1% to 1.1%.

In this embodiment, the fruit juice can be selected from the group consisting of, for example, litchi juice, Rosa Roxburghii juice, prune juice, Hami melon juice, grape juice, peach juice, pineapple juice, pear juice, apple juice, flowerless juice, orange juice, grapefruit juice, passion fruit juice, waxberry juice, pomegranate juice, cherry juice and a mixture thereof, which are common in the food field. Fruit juice can be made by squeezing fruit directly, or by pulping and centrifuging and then taking supernatant. The magnetic immobilized enzyme can be selected from the group consisting of, for example, magnetic immobilized fructosyltransferase, magnetic immobilized glucose oxidase, magnetic immobilized composition enzyme, magnetic immobilized catalase and a mixture thereof, which are commonly used in this field. It should be noted that the fruit juice and magnetic immobilized enzyme mentioned in this paragraph can be selected according to actual needs, which are not exclusively limited in the present application.

In this embodiment, both the liquid inlet 310 and the liquid outlet 320 can either be a hole opened in the fermentation tank 300 and communicated with the inside of the fermentation tank 300, or a pipe inserted in the fermentation tank 300 and configured to communicate the inside of the fermentation tank 300 with the outside environment. Regardless of whether they are holes or pipes, their shapes can be any common shape in the field, such as circle, ellipse, triangle, rectangle, trapezoid, polygon and so on. In addition, it should be noted that the relevant contents such as the liquid inlet 310 and the liquid outlet 320 mentioned in this paragraph can be set according to actual needs, which is not exclusively limited in the present application. It should also be noted that when the fruit juice in the fermentation tank 300 is discharged from the liquid outlet 320, if the magnetic immobilized enzyme adsorbed by the magnetic field generating device and located on the inner wall of the fermentation tank 300 is close to the liquid outlet 320, it will inevitably affect the speed at which the fruit juice flows out of the liquid outlet 320, that is, it will reduce the efficiency of separating the magnetic immobilized enzyme from the fruit juice. Moreover, when the fruit juice flows out of the liquid outlet 320, if the force applied to the magnetic immobilized enzyme due to the flow of fruit juice is greater than the magnetic attraction force of the magnetic field generating device, the magnetic immobilized enzyme will easily flow out of the fermentation tank 300 together with the fruit juice. The magnetic immobilized enzyme flowing out of the fermentation tank 300 together with the fruit juice will not only be reused, but also reduce the quality of the fruit juice. Therefore, in order to avoid the influence of the magnetic immobilized enzyme adsorbed by the magnetic field generating device and located on the inner wall of the fermentation tank 300 on the discharge of the fruit juice, the position of the liquid outlet 320 on the fermentation tank 300 is preferably lower than that of the magnetic field generating device, so that the magnetic immobilized enzyme adsorbed by the magnetic field generating device and located on the inner wall of the fermentation tank 300 will be far away from the liquid outlet 320, and the discharge of fruit juice will not be affected.

In this embodiment, the control of the magnetic field generating device, that is, the control of the magnetic field generating device to generate a magnetic field which penetrates into the fermentation tank 300, can be either manual or automatic. In order to improve the intelligence and automation of equipment for reducing sugar in fruit juice, the control of the magnetic field generating device is preferably automatic; of course, it is not limited to the magnetic field generating device of this embodiment. The same applies to the control methods of the heating device (not shown in the figure), compressed air device 400, pH adjusting device (not shown in the figure), stirring device 600 and electric actuator (not shown in the figure) described in other embodiments below. Specifically, when the magnetic field generating device is automatically controlled, the equipment for reducing sugar in fruit juice includes a controller (not shown in the figure) in addition to the structure given above. The controller is arranged on the frame and is communicatively connected to the magnetic field generating device. The controller is configured to control the magnetic field generating device not to generate a magnetic field which penetrates into the fermentation tank 300 before the enzymolysis reaction starts, so that the magnetic immobilized enzyme in the fermentation tank 300 is dispersed in the fruit juice; to control the magnetic field generating device to generate a magnetic field which penetrates into the fermentation tank 300 after the enzymolysis reaction is completed, so as to adsorb the magnetic immobilized enzyme to the inner wall of the fermentation tank 300. In an embodiment, the controller can be any controller commonly used in the field, such as a microcomputer, a microcontroller such as a single chip microcomputer, an industrial personal computer (IPC), a programmable logic controller (PLC), a distributed control system (DCS), etc., which is not exclusively limited in the present application.

It can be seen from the above that in this embodiment, fruit juice and magnetic immobilized enzyme are introduced into the fermentation tank 300, and the magnetic field generating device is controlled not to generate a magnetic field which penetrates into the fermentation tank 300, so that the magnetic immobilized enzyme in the fermentation tank 300 is dispersed in the fruit juice, and the magnetic immobilized enzyme dispersed in the fruit juice will undergo an the enzymolysis reaction, that is, the sugar in the fruit juice is decomposed into other substances, thereby realizing the sugar reduction of the fruit juice. As time elapses, after the enzymolysis reaction is completed, the magnetic field generating device can be controlled to generate a magnetic field which penetrates into the fermentation tank 300, so that the magnetic immobilized enzyme in the fermentation tank 300 is adsorbed on the inner wall of the fermentation tank 300 by the magnetic field generating device, and then the fruit juice in the fermentation tank 300 can be discharged to obtain sugar-reduced fruit juice. During the process of discharging the fruit juice, the magnetic field generating device will keep adsorbing the magnetic immobilized enzyme on the inner wall of the fermentation tank 300, so that the magnetic immobilized enzyme in the fermentation tank 300 will not be discharged from the fermentation tank 300 together with the fruit juice. That is to say, in this embodiment, the magnetic immobilized enzyme is used to reduce the sugar in fruit juice, and it is not necessary to inactivate the free enzyme by high temperature as in the traditional solutions, so that the sugar reduction process of the fruit juice is simplified, the sugar reduction efficiency is improved, and the nutritional components, flavor and color of the fruit juice can be better retained. In this embodiment, when the fruit juice is discharged from the fermentation tank 300, the magnetic field generating device is used to adsorb the magnetic immobilized enzyme to separate the magnetic immobilized enzyme from the fruit juice. Unlike traditional solutions that rely on centrifugation or filtration for separation, this method enables faster separation of the magnetic immobilized enzyme from the fruit juice. It can also prevent insoluble substances in the fruit juice from adhering to the immobilized enzymes, thereby improving the reuse rate of the immobilized enzyme. In view of this, the sugar-reduced fruit juice made in this embodiment has higher nutritional components and good flavor and color, and can be well applied to maintaining body shape and/or preparing products such as drinks and health products for preventing diseases, such as anti-aging products, anti-radiation products and hypoglycemic products.

In some embodiments, the magnetic field generating device comprises an electromagnetic device (not shown in the figure) and a power supply (not shown in the figure) arranged on the frame, the electromagnetic device is spaced apart from the fermentation tank 300, the electromagnetic device is electrically connected to the power supply, and the power supply is communicatively connected to a controller, and the controller is specifically configured to control the power supply to cut off the supply power to the electromagnetic device before the enzymolysis reaction starts, so that the electromagnetic device does not generate a magnetic field which penetrates into the fermentation tank 300, and the magnetic immobilized enzyme in the fermentation tank 300 is dispersed in fruit juice; to control the power supply to power the electromagnetic device after the enzymolysis reaction is completed, so that the electromagnetic device generates a magnetic field which penetrates into the fermentation tank 300, so as to adsorb the magnetic immobilized enzyme to the inner wall of the fermentation tank 300. It can be seen that whether the magnetic field generating device generates a magnetic field which penetrates into the fermentation tank 300 depends on whether the controller controls the power supply to power on the electromagnetic device. Only when the controller controls the power supply to power on the electromagnetic device, the magnetic field generating device will generate a magnetic field which penetrates into the fermentation tank 300, and the magnetic immobilized enzyme in the fermentation tank 300 will be adsorbed on the inner wall of the fermentation tank 300 by the magnetic field generating device.

In an embodiment, the electromagnetic device includes at least one electromagnet. When the electromagnetic device comprises two electromagnets, the two electromagnets are located on two opposite sides of the fermentation tank 300, and when the electromagnetic device comprises more than two electromagnets, the plurality of electromagnets are arranged around the fermentation tank 300, and any adjacent two electromagnets are spaced apart from each other. The number of power supply can be the same as the number of electromagnets, so that one power supply can only supply power to one electromagnet, or it can be less than the number of electromagnets, so that one power supply can supply power to two or more electromagnets at the same time. As another embodiment, the electromagnetic device comprises an annular electromagnet surrounding the fermentation tank 300. It can be understood that when the electromagnetic device is an annular electromagnet surrounding the fermentation tank 300, it can provide all-round adsorption for the magnetic immobilized enzyme in the fermentation tank 300, which not only improves the efficiency of separating the magnetic immobilized enzyme from the fruit juice, but also makes the separation of the two more complete. It should be noted that the related contents of electromagnetic devices mentioned in this paragraph can be set according to actual needs, which is not exclusively limited in the present application.

In some embodiments, the magnetic field generating device comprises a magnetic attraction device 100, a lifting device (not shown in the figure) and a magnetic shielding plate 200, wherein the magnetic attraction device 100 is arranged on the frame and spaced apart from the fermentation tank 300, the lifting device is arranged on the frame and located between the magnetic attraction device 100 and the fermentation tank 300, the magnetic shielding plate 200 is arranged on the lifting device and is drivingly connected to the lifting device, the lifting device is communicatively connected to the controller, and the controller is specifically configured to control the lifting device to drive the magnetic shielding plate 200 to rise between the magnetic attraction device 100 and the fermentation tank 300 before the enzymolysis reaction starts, so as to prevent the magnetic field generated by the magnetic attraction device 100 from penetrating into the fermentation tank 300, so that the magnetic immobilized enzyme is dispersed in the fruit juice; to control the lifting device to drive the magnetic shielding plate 200 to withdraw from between the magnetic attraction device 100 and the fermentation tank 300 after the enzymolysis reaction is completed, so that the magnetic field generated by the magnetic attraction device 100 penetrates into the fermentation tank 300, so as to adsorb the magnetic immobilized enzyme to the inner wall of the fermentation tank 300. It can be seen that whether the magnetic field generating device generates a magnetic field which penetrates into the fermentation tank 300 depends on whether the controller controls the lifting device to drive the magnetic shielding plate 200 to rise between the magnetic attraction device 100 and the fermentation tank 300. Only when the controller controls the lifting device to drive the magnetic shielding plate 200 to withdraw from between the magnetic attraction device 100 and the fermentation tank 300, that is, when there is no barrier between the magnetic attraction device 100 and the fermentation tank 300 caused by the magnetic shielding plate 200, the magnetic field generating device will generate a magnetic field which penetrates into the fermentation tank 300, and the magnetic immobilized enzyme in the fermentation tank 300 will be adsorbed on the inner wall of the fermentation tank 300 by the magnetic field generating device, and then the fruit juice in the fermentation tank 300 can be discharged.

In an embodiment, the magnetic attraction device 100 comprises an annular magnet surrounding the fermentation tank 300. In an another example, the magnetic attraction device 100 comprises at least one magnet. When the magnetic attraction device 100 comprises two magnets, the two magnets are located on two opposite sides of the fermentation tank 300 respectively, and when the magnetic attraction device 100 comprises more than two magnets, the plurality of magnets are arranged around the fermentation tank 300, and any adjacent two magnets are spaced apart from each other. The number of magnetic shielding plates 200 can be the same as the number of magnets, so that one magnetic shielding plate 200 can only shield one magnet, or it can be smaller than the number of magnets, so that one magnetic shielding plate 200 can shield two or more magnets at the same time. Similarly, the number of lifting devices can be the same as the number of magnetic shielding plates 200, so that one lifting device can only drive one magnetic shielding plate 200 to lift, or it can be smaller than the number of magnetic shielding plates 200, so that one lifting device can drive two or more magnetic shielding plates 200 to lift at the same time. It can be understood that when the magnetic attraction device 100 is an annular magnet surrounding the fermentation tank 300, it provides all-round adsorption for the magnetic immobilized enzyme in the fermentation tank 300, which not only improves the efficiency of separating the magnetic immobilized enzyme from the fruit juice, but also makes the separation of the two more complete. In addition, it should be noted that the relevant contents of the magnetic attraction device 100 mentioned in this paragraph can be set according to actual needs, which is not exclusively limited in the present application.

In some embodiments, in addition to the structure given above, the equipment for reducing sugar in fruit juice comprises a temperature detector (not shown in the figure) and a heating device (not shown in the figure) which are communicatively connected to the controller respectively. The heating device is arranged on the frame and is in contact with the outer wall of the fermentation tank 300, and the temperature detector is arranged on the inner wall of the fermentation tank 300 and configured to be immersed in fruit juice. Specifically, the heating device is configured to heat the fruit juice before the enzymolysis reaction is completed; the temperature detector is configured to detect the temperature of the fruit juice in real time and transmit the temperature of the fruit juice to the controller before the enzymolysis reaction is completed; and the controller is further configured to judge whether the temperature of the fruit juice is within the preset temperature range, and if not, to control the heating device to adjust the heating amount for heating the fruit juice, so that the temperature of the fruit juice is within the preset temperature range. It can be understood that when using the magnetic immobilized enzyme dispersed in fruit juice to reduce sugar, it is necessary to meet certain temperature conditions, that is, the temperature of fruit juice needs to be within the preset temperature range to ensure the activity of the magnetic immobilized enzyme. Therefore, in the present application, a temperature detector and a heating device are arranged to ensure that the temperature of fruit juice is always within the preset temperature range during the enzymolysis reaction, so that the enzymatic hydrolysis reaction can proceed smoothly. In an embodiment, the heating device heats the fruit juice to a temperature of 25° C. to 40° C. for 4 hours to 12 hours, that is, the duration of the enzymolysis reaction is 4 hours to 12 hours. Preferably, when the fruit juice is litchi juice or Rosa Roxburghii juice, the duration of enzymolysis reaction is 4 hours to 10 hours; and when the fruit juice is prune juice, the duration of enzymolysis reaction is 6 hours to 12 hours.

As one embodiment, the heating device comprises a heating jacket (not shown in the figure) and a power source (not shown in the figure) communicatively connected to the controller. The heating jacket is sleeved on the outer wall of the fermentation tank 300, and the power source is arranged on the frame and electrically connected to the heating jacket. Specifically, the power source is configured to transmit a heating current to the heating jacket to heat the heating jacket; the heating jacket is configured to heat the fruit juice through the heat emitted by itself; and the controller is specifically configured to control the power source to adjust the heating current when the temperature of the fruit juice is not within the preset temperature range, so as to adjust the heating amount of the heating jacket for heating the fruit juice, so that the temperature of the fruit juice is within the preset temperature range. That is to say, in this embodiment, the heating jacket is sleeved on the outer wall of the fermentation tank 300, and a heating current is transmitted to the heating jacket through a power source to heat the heating jacket, and then the fruit juice in the fermentation tank 300 is heated by the heat emitted by the heating jacket, and the controller can adjust the heating current at any time by controlling the power source, that is, the heating amount of the heating jacket to heat the fruit juice can be controlled by the controller at any time, so as to finally achieve the purpose that the temperature of the fruit juice in the fermentation tank 300 is always within the preset temperature range.

In this embodiment, the heating jacket comprises an inner layer (not shown in the figure) and an outer layer (not shown in the figure) that are opposite to each other, a heating element (not shown in the figure), a connecting terminal (not shown in the figure) and an insulating layer (not shown in the figure), wherein the inner layer is configured to contact the outer wall of the fermentation tank 300, and the insulating layer is arranged between the inner layer and the outer layer, the heating element is arranged between the insulating layer and the inner layer, and the connecting terminal is arranged on the outer layer, and the heating element is electrically connected to the power source through the connecting terminal. Specifically, the connecting terminal is configured to deliver the heating current provided by the power source to the heating element to heat the heating element; and the heating element is configured to heat the fruit juice through the heat emitted by itself. That is to say, in this embodiment, the heating current is delivered to the heating element by the power source to heat the heating element, and then the fruit juice in the fermentation tank 300 is heated by the heat emitted by the heating element, and an insulating layer is arranged between the heating element and the outer layer, which can effectively prevent heat dissipation and avoid electric leakage. In addition, it should be noted that the heating element can be any device having heating function commonly used in this field, such as resistance wire, heating pipe, etc. The insulating layer can be made of any material having insulating property commonly used in this field, such as asbestos, ceramic fiber, etc. The number of heating elements and the connecting terminals, etc., is not limited to one, and a plurality of them can also be set. The more heating elements, the better the heating effect of the heating jacket on the fruit juice. The relevant contents such as the material of insulating layer, the selection of heating elements and the number of heating elements and terminals mentioned in this paragraph can be set according to actual needs, which are not exclusively limited in the present application.

In an embodiment, the heating device comprises a water storage jacket (not shown in the figure) and a circulating water heating assembly (not shown in the figure), wherein the water storage jacket is sleeved on the outer wall of the fermentation tank 300, the circulating water heating assembly is arranged on the frame and connected to the water storage jacket, and the circulating water heating assembly is communicatively connected to the controller. Specifically, the circulating water heating assembly is configured to circulate the heating water into the water storage jacket and recycle the heating water in the water storage jacket to heat the water storage jacket; the water storage jacket is configured to heat the fruit juice through the heat emitted by itself; and the controller is specifically configured to control the circulating water heating assembly to adjust the temperature of heating water when the temperature of the fruit juice is not within the preset temperature range, so as to adjust the heating amount of the water storage jacket for heating the fruit juice, so that the temperature of the fruit juice is within the preset temperature range. That is to say, in this embodiment, the water storage jacket is sleeved on the outer wall of the fermentation tank 300, and the heating water in the water storage jacket is circulated and recycled by the circulating water heating assembly to heat the water storage jacket, and then the fruit juice in the fermentation tank 300 is heated by the heat emitted by the water storage jacket, and the controller can adjust the temperature of the heating water at any time by controlling the circulating water heating assembly, that is, the heating amount of the water storage jacket for heating the fruit juice can be controlled by the controller at any time, so as to finally achieve the purpose that the temperature of the fruit juice in the fermentation tank 300 is always within the preset temperature range.

In this embodiment, the circulating water heating assembly comprises a circulating water pump (not shown in the figure), a heater (not shown in the figure), a water tank (not shown in the figure), a water inlet pipe (not shown in the figure) and a water return pipe (not shown in the figure). The heater, the water tank and the circulating water pump are all arranged on the frame, the heater is in contact with the outer wall of the water tank, one end of the water inlet pipe is arranged in the water storage jacket, and the opposite end is communicated with the water tank through the circulating water pump, one end of the water return pipe is arranged in the water storage jacket, and the opposite end is communicated with the water tank through the circulating water pump, and the heater and the circulating water pump are communicatively connected to the controller respectively. Specifically, the heater is configured to heat the heating water stored in the water tank; the circulating water pump is configured to circulate the heating water in the water tank into the water storage jacket through the water inlet pipe under the control of the controller, and to recycle the heating water in the water storage jacket into the water tank through the water return pipe to heat the water storage jacket; and the controller is specifically configured to control the heater to adjust the heating amount of the heating water when the temperature of the fruit juice is not within the preset temperature range, to adjust the temperature of the heating water, and further adjust the heating amount of the water storage jacket for heating the fruit juice, so that the temperature of the fruit juice is within the preset temperature range. It can be understood that, compared with the electric heating method in the previous embodiment, in this embodiment, the circulating water heating method is used to heat the fruit juice in the fermentation tank 300, which has the excellent characteristics such as high energy utilization, uniform and stable heating, small load on the power grid, low cost, wide application range, good durability and high safety.

Of course, in addition to the electric heating method in the previous embodiment and the circulating water heating method in this embodiment, in other embodiments, other heating methods such as infrared heating and electromagnetic induction heating commonly used in this field can be used, and even a combination of different heating methods can be used. The specific heating method or methods to be used can be selected according to actual needs, which is not exclusively limited in the present application. In addition, it should be noted that if electromagnetic induction heating is used, a layer of coil can be wound on the outer wall of the fermentation tank 300. When alternating current is applied to the coil, the coil will generate heat, so that the fruit juice in the fermentation tank 300 can be heated. When direct current is applied to the coil, the coil will generate a magnetic field which penetrates into the fermentation tank 300, so that the magnetic immobilized enzyme can be adsorbed on the inner wall of the fermentation tank 300. Alternatively, two layers of coils can be wound on the outer wall of the fermentation tank 300, which include a first coil and a second coil respectively. The first coil is in contact with the outer wall of the fermentation tank 300. When alternating current is applied to the first coil, the first coil will generate heat, so that the fruit juice in the fermentation tank 300 can be heated, and when direct current is applied to the second coil, the second coil will generate a magnetic field which penetrates into the fermentation tank 300, so that the magnetic immobilized enzyme can be adsorbed on the inner wall of the fermentation tank 300. That is to say, when electromagnetic induction heating is used, the magnetic field generating device and the heating device can be integrated into one device, and the heating of fruit juice and the adsorption of magnetic immobilized enzyme can be realized by the one device. Preferably, no matter how many layers of coils are wound on the outer wall of the fermentation tank 300, a shielding layer can be arranged on the side of the coil far away from the fermentation tank 300, which can not only keep warm and prevent heat loss of the coil when the fruit juice is heated, but also avoid interference from external magnetic field when the magnetic immobilized enzyme in the fermentation tank 300 is adsorbed.

In some embodiments, in addition to the structure given above, the equipment for reducing sugar in fruit juice comprises a dissolved oxygen detector (not shown in the figure), a compressed air device 400 and an air delivery pipe 500, wherein the dissolved oxygen detector and the compressed air device 400 are communicatively connected to the controller respectively, the compressed air device 400 is arranged on the frame, the dissolved oxygen detector is arranged on the inner wall of the fermentation tank 300 and is configured to be immersed in the fruit juice, the air delivery pipe 500 is provided with an air inlet end and an air outlet end that are opposite to each other, the air inlet end is connected to the compressed air device 400, and the air outlet end is arranged in the fermentation tank 300 and configured to be inserted into the fruit juice. Specifically, the compressed air device 400 is configured to generate normal-temperature compressed air before the enzymolysis reaction is completed, and to deliver the normal-temperature compressed air to the fruit juice through the gas delivery pipe 500; the dissolved oxygen detector is configured to detect the dissolved oxygen of the fruit juice in real time and transmit the dissolved oxygen of the fruit juice to the controller before the enzymolysis reaction is completed; and the controller is further configured to judge whether the dissolved oxygen of the fruit juice is within the preset dissolved oxygen range, and if not, to control the compressed air device 400 to adjust the delivery amount of the normal-temperature compressed air to the fruit juice, so as to adjust the dissolved oxygen of the fruit juice, so that the dissolved oxygen of the fruit juice is within the preset dissolved oxygen range. It can be understood that, when reducing sugar in fruit juice by using the magnetic immobilized enzyme dispersed in fruit juice, it is necessary to meet certain condition of dissolved oxygen in addition to certain condition of temperature, that is, the dissolved oxygen of fruit juice needs to be within the preset dissolved oxygen range to ensure the activity of the magnetic immobilized enzyme. Therefore, the dissolved oxygen detector, the compressed air device 400 and the gas pipeline 500 are provided in the present application to ensure that the dissolved oxygen of juice is always within the preset dissolved oxygen range during the enzymolysis reaction, so that the enzymolysis reaction can proceed smoothly. In an embodiment, the ventilation rate of normal-temperature compressed air is 1700 m³/h to 3500 m³/h.

In an embodiment, the compressed air device 400 comprises a compressor (not shown in the figure), a driving motor (not shown in the figure), an air filter element (not shown in the figure), a cooler (not shown in the figure) and an air storage tank (not shown in the figure) arranged on the frame, wherein the air filter element, the compressor, the cooler and the air storage tank are connected in sequence, the air storage tank is connected to the air inlet end through a flow control valve, the driving motor is drivingly connected to the compressor, and the driving motor and the flow control valve are respectively communicatively connected to the controller. Specifically, the driving motor is configured to drive the compressor under the control of the controller; the air filter element is configured to filter the air entering the compressor; the compressor is configured to compress air and correspondingly obtaining high-temperature compressed air; the cooler is configured to cool the high-temperature compressed air and correspondingly obtain normal-temperature compressed air; the gas storage tank is configured to store the normal-temperature compressed air; the flow control valve is configured to convey the normal-temperature compressed air in the gas storage tank to the fruit juice through the gas delivery pipe 500; and the controller is specifically configured to control the flow control valve to adjust its opening degree when the dissolved oxygen of the fruit juice is not within the preset dissolved oxygen range, so as to adjust the delivery amount of the normal-temperature compressed air to the fruit juice, so that the dissolved oxygen of the fruit juice is within the preset dissolved oxygen range. That is to say, in this embodiment, the prepared normal-temperature compressed air is stored in the air storage tank, and the air storage tank is communicated with the fruit juice in the fermentation tank 300 through the flow control valve and the air delivery pipe 500, and the controller can adjust the opening degree of the flow control valve at any time by control the flow control valve, that is, adjust the delivery amount of the normal-temperature compressed air in the air storage tank to the fruit juice at any time, thus realizing that the dissolved oxygen of the fruit juice can be controlled by the controller at any time, and finally achieving the purpose that the dissolved oxygen of the fruit juice in the fermentation tank 300 is always within the preset dissolved oxygen range.

In some embodiments, in addition to the structure given above, the equipment for reducing sugar in fruit juice comprises a pH detector (not shown in the figure), a pH adjusting device (not shown in the figure) and a liquid delivery tube (not shown in the figure), where the pH detector and the pH adjusting device are communicatively connected to the controller respectively, the pH adjusting device is arranged on the frame, the pH detector is arranged on the inner wall of the fermentation tank 300 and is configured to be immersed in the fruit juice, and the liquid delivery tube is provided with a liquid inlet end and a liquid outlet end that are opposite to each other, the liquid inlet end is connected to the pH adjusting device, and the liquid outlet end is arranged in the fermentation tank 300 and configured to be inserted into the fruit juice. Specifically, the pH adjusting device is configured to inject an acidic solution and/or an alkaline solution into the fruit juice through the liquid delivery tube before the enzymolysis reaction is completed; the pH detector is configured to detect the pH of the fruit juice in real time and transmit the pH of the fruit juice to the controller before the enzymolysis reaction is completed; and the controller is further configured to judge whether the pH of the fruit juice is within the preset pH range, and if not, to control the pH adjusting device to adjust the injection amount of the acidic solution and/or the alkaline solution into the fruit juice, so as to adjust the pH of the fruit juice, so that the pH of the fruit juice is within the preset pH range. It can be understood that, when reducing sugar in fruit juice by using the magnetic immobilized enzyme dispersed in fruit juice, it is necessary to meet certain condition of pH in addition to certain conditions of temperature and dissolved oxygen, that is, the pH of fruit juice needs to be within the preset pH range to ensure the activity of the magnetic immobilized enzyme. Therefore, a pH detector, a pH adjusting device and a liquid delivery tube are provided in the present application to ensure that the pH of fruit juice is always within the preset pH range during the enzymolysis reaction, so that the enzymolysis reaction can be carried out smoothly. In an embodiment, the pH (that is, the pH value) of the fruit juice is maintained at 3 to 7 by the pH adjusting device.

In an embodiment, the liquid delivery tube comprises an acidic liquid delivery tube (not shown in the figure) and an alkaline liquid delivery tube (not shown in the figure), and the pH adjusting device comprises a metering pump (not shown in the figure), an acidic liquid storage tank (not shown in the figure) and an alkaline liquid storage tank (not shown in the figure) arranged on the frame, wherein the metering pump is communicatively connected to the controller, the acidic liquid storage tank is configured to store the acidic solution, the alkaline liquid storage tank is configured to store the alkaline solution, a liquid outlet end of the acid liquid delivery tube is arranged in the fermentation tank 300 and configured to insert into the fruit juice, a liquid inlet end of the acidic liquid delivery tube is communicated with the acid storage tank through a metering pump, a liquid outlet end of the alkaline liquid delivery tube is arranged in the fermentation tank 300 and configured to insert into the fruit juice, and a liquid inlet end of the alkaline liquid delivery tube is communicated with the alkaline liquid storage tank through the metering pump. Specifically, the metering pump is configured to pump the acidic solution from acidic liquid storage tank and inject it into fruit juice through liquid delivery pipe, and/or pump the alkaline solution from the alkaline liquid storage tank and inject it into fruit juice through the alkaline liquid delivery pipe; and the controller is specifically configured to control the metering pump to adjust the pumping amount of the acidic solution from the acidic liquid storage tank and/or the alkaline solution from the alkaline liquid storage tank when the pH of the fruit juice is not within the preset pH range, so as to adjust the injection amount of acidic solution and/or alkaline solution into the fruit juice, and further adjust the pH of the fruit juice so that the pH of the fruit juice is within the preset pH range. That is to say, in this embodiment, the acidic solution is placed in the acidic liquid storage tank and the alkaline solution is placed in the alkaline liquid storage tank, and the acidic liquid storage tank and the fruit juice in the fermentation tank 300 are communicated through the metering pump and the acidic liquid delivery pipe, the alkaline liquid storage tank and the fruit juice in the fermentation tank 300 are communicated through the metering pump and the alkaline liquid delivery pipe, and the controller can adjust the pumping amount of the acid solution from the acid storage tank and/or the pumping amount of alkaline solution from the alkaline liquid storage tank at any time by controlling the metering pump, that is, adjust the injection amount of acid solution and/or alkaline solution into the fruit juice at any time, thus realizing that the pH of the fruit juice can be controlled by the controller at any time, and finally achieving the purpose that the pH of the fruit juice in the fermentation tank 300 is always within the preset pH range.

In some embodiments, in addition to the structure given above, the equipment for reducing sugar in fruit juice comprises a stirring device 600 arranged on the inner wall of the fermentation tank 300 and communicatively connected to the controller, and the controller is further configured to control the stirring device 600 to stir the fruit juice before the enzymolysis reaction is completed. It can be understood that, when reducing sugar in fruit juice by using the magnetic immobilized enzyme dispersed in fruit juice, it is necessary to meet certain condition of stirring in addition to certain conditions of temperature, dissolved oxygen and pH. Therefore, a stirring device 600 is provided in the present application, and the controller can control the stirring device 600 to stir the fruit juice at any time during the enzymolysis reaction. The advantages are: to make the magnetic immobilized enzyme fully contact with the fruit juice, increase the chance of collision between the magnetic immobilized enzyme and the substrate (i.e., the sugar in the fruit juice), so as to accelerate the rate of enzymatic reaction; to prevent the concentration of sugar in the fruit juice from being different in the local area, and ensure the uniformity of the concentration of the sugar in the whole reaction system, so as to make the magnetic immobilized enzyme act on sugar more effectively; to help disperse the products generated by the enzyme reaction in time, avoid local product accumulation from inhibiting the subsequent enzymolysis reaction, and also facilitate the diffusion of substrate to the active site of magnetic immobilized enzyme; to maintain the temperature of the reaction system uniform to a certain extent, to reduce the adverse effect of local overheating or supercooling on the activity of magnetic immobilized enzyme; to reduce the aggregation of magnetic immobilized enzyme, make the magnetic immobilized enzyme more evenly distributed in fruit juice, and can give full play to the catalytic role of magnetic immobilized enzyme. Of course, the stirring device 600 can also be replaced by an oscillating device, that is, the stirring of fruit juice can be replaced by the oscillation of fruit juice. Whether to stir or oscillate can be selected according to actual needs, which is not exclusively limited in the present application.

In an embodiment, the stirring device 600 includes a stirring blade (not shown in the figure) and a stirring motor (not shown in the figure) communicatively connected to the controller, wherein the stirring motor is arranged on the inner wall of the fermentation tank 300 and is drivingly connected to the stirring blade, and the controller is specifically configured to control the stirring motor to drive the stirring blade to rotate before the enzymolysis reaction is completed, so as to stir the fruit juice through the rotation of the stirring blade. That is to say, in this embodiment, a stirring motor is arranged on the inner wall of the fermentation tank 300 (preferably the inner wall of the bottom of the fermentation tank 300), and the output shaft of the stirring motor is connected with the stirring blade, so that the controller can control the output shaft of the stirring motor to rotate at any time during the enzymolysis reaction, thus the stirring blade is driven to rotate by the output shaft of the stirring motor, and the fruit juice is stirred by the rotation of the stirring blade. In an embodiment, the rotating speed of the stirring blade is 100 rpm/min to 500 rpm/min when the stirring motor drives the stirring blade to rotate.

It should be noted that the stirring motor is not limited to being arranged on the inner wall of the fermentation tank 300. In other embodiments, the stirring motor also can be arranged on the outer wall of the fermentation tank 300. At this time, the output shaft of the stirring motor needs to be inserted into the fermentation tank 300 and connected with the stirring blade in the fermentation tank 300. It should also be noted that although the mechanical stirring method is used in this embodiment, in other embodiments, other stirring methods such as magnetic stirring and aeration stirring commonly used in this field can be used, or even a combination of different stirring methods can be used. The specific stirring method or methods to be used can be selected according to actual needs, which is not exclusively limited in the present application. In addition, it is worth noting that when magnetic stirring is used, the magnetic stirrer (referred to as stir bar, which refers to small magnet used to stir the liquid in the magnetic stirrer) may adsorb the magnetic immobilized enzyme in the fruit juice, which affects the full contact between the magnetic immobilized enzyme and the fruit juice, that is, affects the enzymolysis reaction of the magnetic immobilized enzyme in the fruit juice, and reduces the sugar reduction effect of the fruit juice. Therefore, the stir bar needs to have a high stirring speed, so as to generate a large centrifugal force while stirring the fruit juice into a vortex. This large centrifugal force makes the stir bar not adsorb the magnetic immobilized enzyme, but throw it into the fruit juice, thus avoiding the magnetic immobilized enzyme from being adsorbed by the stir bar during magnetic stirring and ensuring the sugar reduction effect of the fruit juice.

In some embodiments, in addition to the structure given above, the equipment for reducing sugar in fruit juice comprises a pressure detector (not shown in the figure), an electric actuator (not shown in the figure) and an exhaust valve (not shown in the figure), and the fermentation tank 300 is further provided with an exhaust port 330 communicated with the inside of the fermentation tank, the exhaust valve is arranged in the exhaust port 330, the electric actuator is arranged on the exhaust valve and is drivingly connected to the exhaust valve, and the pressure detector is arranged on the inner wall of the fermentation tank 300, and the pressure detector and the electric actuator are communicatively connected to the controller respectively. Specifically, the electric actuator is configured to open or close the exhaust valve; the pressure detector is configured to detect the pressure in the fermentation tank 300 in real time and transmit the pressure in the fermentation tank 300 to the controller before the enzymolysis reaction is completed; and the controller is not only configured to judge whether the pressure in the fermentation tank 300 exceeds the preset safe pressure range, but also to control the electric actuator to open the exhaust valve when the pressure exceeds the safe pressure range, so as to exhaust the gas in the fermentation tank 300, so that the pressure in the fermentation tank 300 returns to safe pressure range, and to control the electric actuator to close the exhaust valve after the pressure in the fermentation tank 300 returns to the safe pressure range. It can be understood that, when reducing sugar in fruit juice by using magnetic immobilized enzyme dispersed in fruit juice, it is necessary to meet certain condition of pressure in addition to certain conditions of temperature, dissolved oxygen, pH and stirring. During the enzymolysis reaction, some gases may be generated, which will increase the pressure in the fermentation tank 300, and excessive pressure in the fermentation tank 300 will affect the enzymolysis reaction and even lead to safety accidents. Therefore, a pressure detector, an electric actuator and an exhaust valve are provided in the present application, and the controller can control the electric actuator to open or close the exhaust valve at any time, so as to exhaust the gas in the fermentation tank 300, reduce the pressure in the fermentation tank 300, and finally achieve the purpose that the pressure in the fermentation tank 300 is always within the safe pressure range.

Please refer to FIG. 2, which is a flow chart of the method for reducing sugar in fruit juice. The method for reducing sugar in fruit juice is provided according to this embodiment, which comprises the following steps 201 to 203 (abbreviated as S201 to S203).

S201, Preparing a magnetic carrier.

In this embodiment, when reducing sugar in fruit juice, the magnetic immobilized enzyme needs to be mixed in the fruit juice, and the enzymolysis reaction of the magnetic immobilized enzyme in the fruit juice is used, that is, the magnetic immobilized enzyme is used to decompose the sugar in the fruit juice into other substances, thereby achieving sugar reduction in the fruit juice. That is to say, before the magnetic immobilized enzyme is mixed in fruit juice, it is necessary to prepare the magnetic immobilized enzyme, and the first step in preparing the magnetic immobilized enzyme is to prepare a magnetic carrier for immobilizing the enzyme.

In some embodiments, please refer to FIG. 3, which is a schematic flow chart of S201 in FIG. 2. S201, that is, the step of preparing the magnetic carrier, includes the following steps 2011 to 2015 (abbreviated as S2011 to S2015): S2011, dissolving ferric chloride hexahydrate and ferrous chloride tetrahydrate in water to obtain a first mixed solution; S2012, adding chitosan into the first mixed solution, and stirring to obtain a second mixed solution; S2013, adding sodium hydroxide solution into the second mixed solution, heating and stirring to obtain a third mixed solution, cooling the third mixed solution, and adjusting the pH of the third mixed solution; S2014, adding glutaraldehyde solution into the third mixed solution, and heating and stirring to obtain a fourth mixed solution in which the magnetic carrier is dispersed; S2015, absorbing out the magnetic carrier in the fourth mixed solution with a magnet, and dispersing the magnetic carrier in the boric acid solution to obtain a magnetic carrier dispersion. In addition, it should be noted that S2011 to S2013 need to be carried out under protective gas, such as nitrogen, argon and helium, to create an oxygen-free, water-free and other impurity-free environment, so as to ensure the smooth progress of chemical reaction and the quality of the first mixed solution. It should also be noted that for S2015, after the adsorbed magnetic carrier is dispersed in boric acid solution, the obtained magnetic carrier dispersion needs to be refrigerated for subsequent use if it is not used immediately. In an embodiment, when preparing the magnetic carrier, in parts by mass, 0.8 parts to 1.2 parts of ferric chloride hexahydrate, 0.4 parts to 0.5 parts of ferrous chloride tetrahydrate, 0.05 parts to 0.07 parts of chitosan, 12 parts to 18 parts of sodium hydroxide solution and 4.5 parts to 5 parts of glutaraldehyde solution are used, where the solid raw material is calculated as 1 g/part and the liquid raw material as 1 mL/part; the mass concentration of sodium hydroxide solution in S2013 is 3.5% to 4.5%, heated to 63° C. to 68° C. and maintained for 1 hours to 2 hours, and the pH is adjusted to 10 to 12, preferably 11; and the mass concentration of glutaraldehyde solution in S2014 is 8% to 12%, heated to 28° C. to 35° C. and maintained for 15 hours to 18 hours.

In an embodiment, 1.0 part of ferric chloride hexahydrate and 0.45 part of ferrous chloride tetrahydrate were dissolved in water at room temperature to obtain a first mixed solution; 0.06 part of chitosan was added into the first mixed solution, and stirred until the chitosan was fully dissolved to obtain a second mixed solution; 15 parts of 4% sodium hydroxide solution were added into the second mixed solution, stirred for 1 hour, then heated to 65° C. and stirred for another 1 hour, and cooled, and the pH was adjusted to 11; 4.8 parts of glutaraldehyde solution with a mass concentration of 10% was added to the third mixed solution, which was heated to 30° C. and stirred for 16 hours to obtain a fourth mixed solution in which the magnetic carrier was dispersed; a magnet was used to adsorb the magnetic carrier in the fourth mixed solution, which was washed with pure water and then dried in vacuum at low temperature for subsequent use, or the washed magnetic carrier was dispersed in boric acid solution to obtain a magnetic carrier dispersion for subsequent use.

S202, Immobilizing an enzyme on the magnetic carrier to obtain a magnetic immobilized enzyme.

In this embodiment, after the preparation of the magnetic carrier for immobilizing the enzyme, the enzyme can be immobilized on the magnetic carrier, and finally the magnetic immobilized enzyme can be obtained.

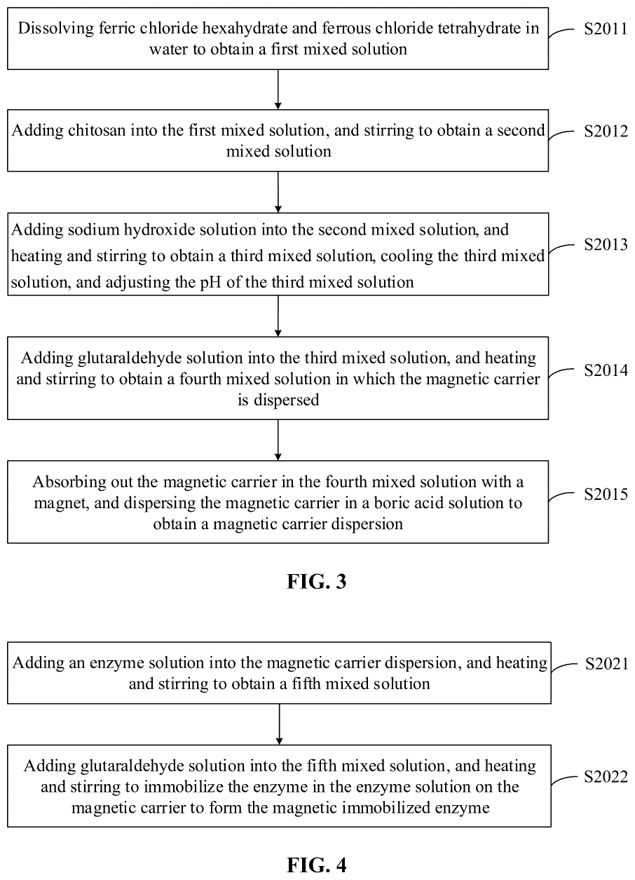

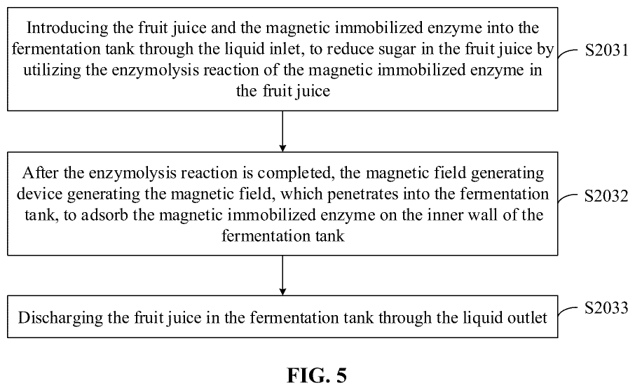

In some embodiments, please refer to FIG. 4, which is a schematic flow chart of S202 in FIG. 2. S202, the step of immobilizing the enzyme on the magnetic carrier to obtain the magnetic immobilized enzyme, comprises the following steps 2021 and 2022 (abbreviated as S2021 and S2022): S2021, adding an enzyme solution into the magnetic carrier dispersion, heating and stirring to obtain a fifth mixed solution; S2022, adding glutaraldehyde solution into the fifth mixed solution, and heating and stirring to immobilize the enzyme in the enzyme solution on the magnetic carrier to form the magnetic immobilized enzyme. In addition, it should be noted that for S2022, after the magnetic immobilized enzyme is formed in the fifth mixed solution, the magnetic immobilized enzyme in the fifth mixed solution needs to be adsorbed by a magnet, and the adsorbed magnetic immobilized enzyme is washed, and then the washed magnetic immobilized enzyme is dispersed in pure water. The pure water in which the magnetic immobilized enzymes are dispersed needs to be refrigerated for subsequent use if it is not used immediately. The pure water used to disperse magnetic immobilized enzymes generally refers to any feasible water such as deionized water, distilled water, ion exchange water, double distilled water, high purity water and purified water that can be used in food fields. It should also be noted that it can be seen from S2021 and S2022 that in the present application, the magnetic immobilized enzyme is prepared by cross-linking method, that is, cross-linking agents such as glutaraldehyde, hexamethylene diamine and maleic anhydride are used to cause cross-linking reaction between the enzyme and the magnetic carrier, thereby forming a network structure, and then the enzyme is immobilized on the magnetic carrier, which has the advantages of firm combination and high stability. In an embodiment, in S2021, the mass-volume ratio of magnetic carrier to enzyme solution is 1: (18-22), the concentration of enzyme solution is 200,000 U/mL to 300,000 U/mL, and the mixture is heated to 33° C. to 38° C. and maintained for 0.5 hours to 2 hours; and in S2022, the concentration of glutaraldehyde solution is 8% to 12%, and the mixture is heated to 33° C. to 38° C. and maintained for 15 hours to 18 hours. The enzyme in the enzyme solution can be any one or a combination of multiple enzymes commonly used in the field, such as fructosyltransferase, glucose oxidase, complex enzyme and catalase.

In an embodiment, according to the mass-volume ratio of magnetic carrier to enzyme solution of 1:20, the enzyme solution was added into the magnetic carrier dispersion, heated to 35° C. and stirred for 1 hour to obtain a fifth mixed solution; 0.02 part of glutaraldehyde solution with mass concentration of 10% was added into the fifth mixed solution, heated to 35° C., and stirred for 16 hours, so that the enzyme in the enzyme solution is immobilized on the magnetic carrier to form a magnetic immobilized enzyme; a magnet was used to adsorb the magnetic immobilized enzyme in the fifth mixed solution, which was washed with pure water and then dried in vacuum at low temperature for subsequent use, or the washed magnetic immobilized enzyme was dispersed in pure water and refrigerated for subsequent use.

S203, Reducing sugar in fruit juice by an equipment for reducing sugar in fruit juice and the magnetic immobilized enzyme.

In this embodiment, after obtaining the magnetic immobilized enzyme used for reducing sugar, sugar in the fruit juice can be reduced by the magnetic immobilized enzyme and the equipment for reducing sugar in fruit juice provided by the present application, that is, the fruit juice and the magnetic immobilized enzyme are introduced into the fermentation tank 300 of the equipment for reducing sugar in fruit juice, and sugar in the fruit juice can be reduced by the enzymolysis reaction of the magnetic immobilized enzyme in the fruit juice.

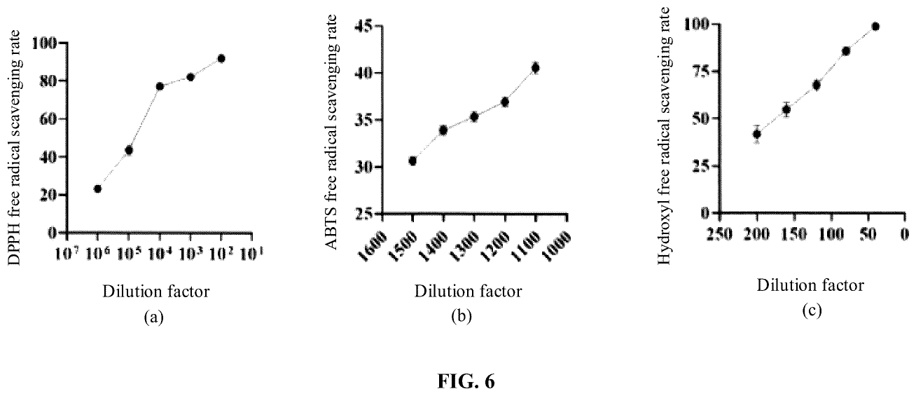

In some embodiments, please refer to FIG. 5, which is a schematic flow chart of S203 in FIG. 2. S203, the step of reducing sugar in fruit juice by the equipment for reducing sugar in fruit juice and the magnetic immobilized enzyme, comprises steps 2031 to 2033 (abbreviated as S2031 to S2033): S2031, introducing the fruit juice and the magnetic immobilized enzyme into the fermentation tank through the liquid inlet, to reduce sugar in the fruit juice by utilizing the enzymolysis reaction of the magnetic immobilized enzyme in the fruit juice; S2032, after the enzymolysis reaction is completed, the magnetic field generating device generating the magnetic field, which penetrates into the fermentation tank, to adsorb the magnetic immobilized enzyme on the inner wall of the fermentation tank; S2033, discharging the fruit juice in the fermentation tank through the liquid outlet. In addition, for S203, the step of reducing sugar in fruit juice by an equipment for reducing sugar in fruit juice and the magnetic immobilized enzyme, the unmentioned aspects, such as the steps of adjusting the temperature, pH, dissolved oxygen, and stirring of the fruit juice, can be referred to the previous relevant description of the equipment for reducing sugar in fruit juice, and the application will not repeat them here.

In the present application, sugar-reduced fruit juice was prepared by the equipment/method for reducing sugar in fruit juice described above, and tests have been conducted on different aspects during the preparation process. The test results of each aspect will be described in detail below.

In a first aspect, the activity of different magnetic immobilized enzymes in different pH ranges was tested, and the test results are shown in Table 1 below. In Table 1, the magnetic immobilized enzyme is referred to as the name of free enzyme. The activity of magnetic immobilized fructosyltransferase was tested by GB/T 23528-2009. The activity of magnetic immobilized complex enzyme was tested using the method described in Journal of Wuxi University of Light Industry, Volume 23, Issue 4, “Determination of glucoamylase activity in complex enzyme”. The activity of magnetic immobilized catalase was tested using the method described in Materials Reports: Research Section”, September 2009 (Part 2), Volume 23, Issue 9, “Study on the Immobilization of Catalase by AB-8 Macroporous Absorbent Resin”. The activity of magnetic immobilized glucose oxidase was tested using the national standard method (i.e. Method for Determination of Glucose Oxidase Activity).

TABLE 1

| | | Complex | Glucose | |
|---|---|---|---|---|
| pH | Fructosyltransferase | enzyme | oxidase | Catalase |
| value | (U/g) | (U/g) | (U/g) | (U/g) |
| 3 | 130.6 | 110.1 | 17.34 | 139.2 |
| 4 | 139.1 | 122.7 | 17.95 | 152.7 |
| 5 | 125.8 | 115.9 | 16.82 | 144.4 |
| 6 | 121.7 | 103.4 | 16.73 | 138.1 |

It can be seen from Table 1 that the magnetic immobilized fructosyltransferase, magnetic immobilized glucose oxidase, magnetic immobilized complex enzyme and magnetic immobilized catalase all have relatively good activity in the environment with pH value of 3 to 6.

In a second aspect, the sugar reduction effects of different magnetic immobilized enzymes on different fruit juices were tested. The test results are shown in Table 2, Table 3 and Table 4 below. Table 2 shows the sugar reduction effects of different magnetic immobilized enzymes on litchi juice, Table 3 shows the sugar reduction effects of different magnetic immobilized enzymes on Rosa Roxburghii juice, and Table 4 shows the sugar reduction effects of different magnetic immobilized enzymes on prune juice. In addition, it should be noted that in Table 2, Table 3 and Table 4, the magnetic immobilized enzyme is referred to by the name of free enzyme. Taking the fructosyltransferase (0.3%) in the third row of Table 2 as an example, it indicates that the concentration of magnetic fructosyltransferase (that is, the mass-volume ratio of magnetic fructosyltransferase to litchi juice) is 0.3%.

TABLE 2

| | | | | Total | | | Total |
|---|---|---|---|---|---|---|---|
| | Fructose | Sucrose | Glucose | sugar | Glucose | Sucrose | sugar |
| | content | content | content | content | reduction | reduction | reduction |
| Litchi juice | (g/L) | (g/L) | (g/L) | (g/L) | rate(%) | rate (%) | rate (%) |
| Before enzymolysis | 38.87 | 31.74 | 78.56 | 149.17 | — | — | — |
| reaction | | | | | | | |
| Fructosyltransferase | 35.31 | 21.16 | 87.37 | 143.84 | −11.21 | 33.33 | 3.57 |
| (0.3%) | | | | | | | |
| Fructosyltransferase | 42.73 | 17.58 | 60.52 | 120.83 | 22.96 | 44.61 | 19.00 |
| (0.3%) + Glucose oxidase | | | | | | | |
| (0.03%) | | | | | | | |
| Fructosyltransferase | 42.12 | 18.81 | 57.36 | 118.29 | 26.99 | 40.74 | 20.70 |
| (0.3%) + Glucose oxidase | | | | | | | |
| (0.1%) | | | | | | | |
| Fructosyltransferase | 41.98 | 17.92 | 55.48 | 115.38 | 29.38 | 43.54 | 22.65 |
| (0.3%) + Glucose oxidase | | | | | | | |
| (0.3%) | | | | | | | |
| Complex enzyme (0.3%) | 39.93 | 29.35 | 69.01 | 138.29 | 12.16 | 7.53 | 7.29 |
| Complex enzyme (0.3%) + | 40.13 | 28.57 | 66.23 | 134.93 | 15.70 | 9.99 | 9.55 |
| Glucose oxidase (0.03%) | | | | | | | |
| Complex enzyme (0.3%) + | 41.44 | 28.11 | 65.79 | 135.34 | 16.26 | 11.44 | 9.27 |
| Glucose oxidase (0.1%) | | | | | | | |
| Complex enzyme (0.3%) + | 41.9 | 28.76 | 63.28 | 133.94 | 19.45 | 9.39 | 10.21 |
| Glucose oxidase (0.3%) | | | | | | | |
| Complex enzyme (0.2%) + | 41.23 | 26.45 | 78.01 | 145.69 | 0.70 | 16.67 | 2.33 |
| Fructosyltransferase | | | | | | | |
| (0.1%) | | | | | | | |
| Complex enzyme (0.2%) + | 46.71 | 24.69 | 66.34 | 137.74 | 15.55 | 22.21 | 7.66 |
| Fructosyltransferase | | | | | | | |
| (0.1%) + Glucose oxidase | | | | | | | |
| (0.03%) | | | | | | | |
| Fructosyltransferase | 45.38 | 16.93 | 50.17 | 112.48 | 36.14 | 46.66 | 24.60 |
| (0.3%) + Glucose oxidase | | | | | | | |
| (0.05%) + Catalase (0.5%) | | | | | | | |
| Glucose oxidase (0.05%) + | 41.28 | 28.3 | 41.03 | 110.61 | 47.77 | 10.84 | 25.85 |
| Catalase (0.4%) | | | | | | | |
| Glucose oxidase (0.1%) + | 43.51 | 26.66 | 39.99 | 110.16 | 49.10 | 16.01 | 26.15 |
| Catalase (0.2%) | | | | | | | |
| Glucose oxidase (0.1%) + | 44.89 | 23.47 | 38.76 | 107.12 | 50.66 | 26.06 | 28.19 |
| Catalase (1%) | | | | | | | |

It can be seen from Table 2 that among the magnetic immobilized fructosyltransferase, magnetic immobilized complex enzyme, magnetic immobilized glucose oxidase and magnetic immobilized catalase, one magnetic immobilized enzyme can be used to reduce sugar in litchi juice. For example, magnetic immobilized fructosyltransferase or magnetic immobilized complex enzyme can be used to reduce sugar in litchi juice. Alternatively, a combination of two or more magnetic immobilized enzymes can be used to reduce sugar in litchi juice, for example, the combination of magnetic immobilized glucose oxidase and magnetic immobilized catalase is used to reduce sugar in litchi juice, or the combination of magnetic immobilized fructosyltransferase and magnetic immobilized glucose oxidase is used to reduce sugar in litchi juice. The effect of reducing sugar in litchi juice by using the combination of two or more magnetic immobilized enzymes is better, especially the combination of magnetic immobilized glucose oxidase and magnetic immobilized catalase is particularly optimal, that is, the total sugar reduction rate is the highest.

TABLE 3

| | | | | Total | | | Total |
|---|---|---|---|---|---|---|---|
| | Fructose | Sucrose | Glucose | sugar | Glucose | Sucrose | sugar |
| | content | content | content | content | reduction | reduction | reduction |
| Rosa Roxburghii juice | (g/L) | (g/L) | (g/L) | (g/L) | rate(%) | rate (%) | rate (%) |
| Before enzymolysis | 13.75 | 18.77 | 14.43 | 46.75 | — | — | — |
| reaction | | | | | | | |
| Fructosyltransferase | 13.98 | 10.89 | 20.11 | 44.98 | −39.36 | 41.98 | 3.79 |
| (0.3%) | | | | | | | |
| Fructosyltransferase | 14.29 | 10.13 | 16.91 | 41.33 | −17.19 | 46.03 | 12.05 |
| (0.3%) + Glucose oxidase | | | | | | | |
| (0.03%) | | | | | | | |
| Fructosyltransferase | 14.33 | 9.98 | 15.37 | 39.68 | −6.51 | 46.83 | 17.11 |
| (0.3%) + Glucose oxidase | | | | | | | |
| (0.1%) | | | | | | | |
| Fructosyltransferase | 14.58 | 9.87 | 15.02 | 39.47 | −4.09 | 47.42 | 18.35 |
| (0.3%) + Glucose oxidase | | | | | | | |
| (0.3%) | | | | | | | |
| Complex enzyme (0.3%) | 12.77 | 16.96 | 16.91 | 46.64 | −17.19 | 9.64 | 0.28 |
| Complex enzyme (0.3%) + | 13.06 | 15.91 | 15.98 | 44.95 | −10.74 | 15.24 | 3.86 |
| Glucose oxidase (0.03%) | | | | | | | |
| Complex enzyme (0.3%) + | 14.22 | 14.98 | 15.31 | 44.51 | −6.10 | 20.19 | 4.98 |
| Glucose oxidase (0.1%) | | | | | | | |
| Complex enzyme (0.3%) + | 15.16 | 13.77 | 15.02 | 43.95 | −4.09 | 26.64 | 6.29 |
| Glucose oxidase (0.3%) | | | | | | | |
| Complex enzyme (0.2%) + | 14.37 | 13.1 | 18.95 | 46.42 | −31.32 | 30.21 | 0.75 |
| Fructosyltransferase | | | | | | | |
| (0.1%) | | | | | | | |
| Complex enzyme (0.2%) + | 15.58 | 12.72 | 17.1 | 45.4 | −18.50 | 32.23 | 2.91 |
| Fructosyltransferase | | | | | | | |
| (0.1%) + Glucose oxidase | | | | | | | |
| (0.03%) | | | | | | | |
| Fructosyltransferase | 15.66 | 11.02 | 15.89 | 42.57 | −10.12 | 41.29 | 9.21 |
| (0.3%) + Glucose oxidase | | | | | | | |
| (0.05%) + Catalase (0.5%) | | | | | | | |
| Glucose oxidase (0.05%) + | 14.11 | 17.04 | 8.61 | 39.76 | 40.33 | 9.22 | 16.42 |
| Catalase (0.4%) | | | | | | | |
| Glucose oxidase (0.1%) + | 14.23 | 16.88 | 8.12 | 39.23 | 43.73 | 10.07 | 18.91 |
| Catalase (0.2%) | | | | | | | |
| Glucose oxidase (0.1%) + | 14.78 | 16.25 | 7.39 | 38.42 | 48.79 | 13.43 | 21.23 |
| Catalase (1%) | | | | | | | |

It can be seen from Table 3 that among the magnetic immobilized fructosyltransferase, magnetic immobilized complex enzyme, magnetic immobilized glucose oxidase and magnetic immobilized catalase, one magnetic immobilized enzyme can be used to reduce sugar in Rosa Roxburghii juice. For example, magnetic immobilized fructosyltransferase or magnetic immobilized complex enzyme can be used to reduce sugar in Rosa Roxburghii juice. Alternatively, a combination of two or more magnetic immobilized enzymes can be used to reduce sugar in Rosa Roxburghii juice, for example, the combination of magnetic immobilized glucose oxidase and magnetic immobilized catalase is used to reduce sugar in Rosa Roxburghii juice, or the combination of magnetic immobilized fructosyltransferase and magnetic immobilized glucose oxidase is used to reduce sugar in Rosa Roxburghii juice. The effect of reducing sugar in Rosa Roxburghii juice by using the combination of two or more magnetic immobilized enzymes is better, especially the combination of magnetic immobilized glucose oxidase and magnetic immobilized catalase is particularly optimal, that is, the total sugar reduction rate is the highest.

TABLE 4

| | | | | Total | | | Total |
|---|---|---|---|---|---|---|---|
| | Fructose | Sucrose | Glucose | sugar | Glucose | Sucrose | sugar |
| | content | content | content | content | reduction | reduction | reduction |
| Prune juice | (g/L) | (g/L) | (g/L) | (g/L) | rate(%) | rate (%) | rate (%) |
| Before enzymolysis | 75.89 | 14.23 | 103.19 | 193.31 | — | — | — |
| reaction | | | | | | | |
| Fructosyltransferase | 74.99 | 5.87 | 104.16 | 185.02 | −0.94 | 58.75 | 4.29 |
| (0.3%) | | | | | | | |
| Fructosyltransferase | 75.33 | 5.75 | 102.34 | 183.42 | 0.82 | 59.59 | 5.12 |
| (0.3%) + Glucose oxidase | | | | | | | |
| (0.03%) | | | | | | | |
| Fructosyltransferase | 75.97 | 5.62 | 101.16 | 182.75 | 1.97 | 60.51 | 5.46 |
| (0.3%) + Glucose oxidase | | | | | | | |
| (0.1%) | | | | | | | |
| Fructosyltransferase | 76.14 | 5.41 | 99.07 | 180.62 | 3.99 | 61.98 | 6.56 |
| (0.3%) + Glucose oxidase | | | | | | | |
| (0.3%) | | | | | | | |
| Complex enzyme (0.3%) | 74.15 | 6.79 | 105.32 | 186.26 | −2.06 | 52.28 | 3.65 |
| Complex enzyme (0.3%) + | 74.98 | 6.12 | 101.33 | 182.43 | 1.80 | 56.99 | 5.63 |
| Glucose oxidase (0.03%) | | | | | | | |
| Complex enzyme (0.3%) + | 75.26 | 5.82 | 99.25 | 180.33 | 3.82 | 59.10 | 6.71 |
| Glucose oxidase (0.1%) | | | | | | | |
| Complex enzyme (0.3%) + | 75.83 | 5.23 | 98.37 | 179.43 | 4.67 | 63.25 | 7.18 |
| Glucose oxidase (0.3%) | | | | | | | |
| Complex enzyme (0.2%) + | 73.94 | 8.83 | 98.42 | 181.19 | 4.62 | 37.95 | 6.27 |
| Fructosyltransferase | | | | | | | |
| (0.1%) | | | | | | | |
| Complex enzyme (0.2%) + | 75.37 | 5.37 | 91.23 | 171.97 | 11.59 | 62.26 | 11.04 |
| Fructosyltransferase | | | | | | | |
| (0.1%) + Glucose oxidase | | | | | | | |
| (0.03%) | | | | | | | |
| Fructosyltransferase | 75.39 | 5.62 | 88.54 | 169.55 | 14.20 | 60.51 | 12.29 |
| (0.3%) + Glucose oxidase | | | | | | | |
| (0.05%) + Catalase (0.5%)) | | | | | | | |
| Glucose oxidase (0.05%) + | 78.32 | 10.04 | 46.78 | 135.14 | 54.67 | 29.44 | 30.09 |
| Catalase (0.4%) | | | | | | | |
| Glucose oxidase (0.1%) + | 79.89 | 8.72 | 46.44 | 135.05 | 55.00 | 38.72 | 30.14 |
| Catalase (0.2%) | | | | | | | |
| Glucose oxidase (0.1%) + | 80.33 | 7.11 | 38.21 | 125.65 | 62.97 | 50.04 | 35.00 |
| Catalase (1%) | | | | | | | |

As can be seen from Table 4, among the magnetic immobilized fructosyltransferase, magnetic immobilized complex enzyme, magnetic immobilized glucose oxidase and magnetic immobilized catalase, one magnetic immobilized enzyme can be used to reduce sugar in prune juice. For example, magnetic immobilized fructosyltransferase or magnetic immobilized complex enzyme can be used to reduce sugar in prune juice. Alternatively, a combination of two or more magnetic immobilized enzymes can be used to reduce sugar in prune juice, for example, the combination of magnetic immobilized glucose oxidase and magnetic immobilized catalase is used to reduce sugar in prune juice, or the combination of magnetic immobilized fructosyltransferase and magnetic immobilized glucose oxidase is used to reduce sugar in prune juice. The effect of reducing sugar in prune juice by using the combination of two or more magnetic immobilized enzymes is better, especially the combination of magnetic immobilized glucose oxidase and magnetic immobilized catalase is particularly optimal, that is, the total sugar reduction rate is the highest.

In a third aspect, the sugar reduction effects of different magnetic immobilized enzymes on prune juice were tested with and without the introduction of compressed air, and the test results are shown in Table 5 below. In Table 5, the magnetic immobilized enzyme is referred to by the name of free enzyme, and the introduction of compressed air is abbreviated as aeration, and without the introduction of compressed air is abbreviated as non-aeration.

TABLE 5

| | | | | | Total | | | Total |
|---|---|---|---|---|---|---|---|---|
| | | Fructose | Sucrose | Glucose | sugar | Glucose | Sucrose | sugar |
| | | content | content | content | content | reduction | reduction | reduction |
| Prune juice | operation | (g/L) | (g/L) | (g/L) | (g/L) | rate(%) | rate (%) | rate (%) |
| Before | — | 77.34 | 13.89 | 102.37 | 193.6 | — | — | — |
| enzymolysis | | | | | | | | |
| reaction | | | | | | | | |
| Glucose oxidase | Non- | 78.95 | 11.25 | 66.78 | 156.98 | 34.77 | 19.01 | 18.92 |
| (0.1%) | aeration | | | | | | | |
| Glucose oxidase | aeration | 79.32 | 10.97 | 59.37 | 149.66 | 42.00 | 21.02 | 22.70 |
| (0.1%) | | | | | | | | |
| Glucose oxidase | Non- | 80.99 | 8.38 | 42.39 | 131.76 | 58.59 | 39.67 | 31.94 |
| (0.1%) + Catalase | aeration | | | | | | | |
| (1%) | | | | | | | | |
| Glucose oxidase | aeration | 82.56 | 6.85 | 36.72 | 126.13 | 64.13 | 50.68 | 34.85 |
| (0.1%) + Catalase | | | | | | | | |
| (1%) | | | | | | | | |

It can be seen from Table 5 that the introduction of compressed air can promote the enzymolysis reaction of magnetic immobilized enzyme in fruit juice (such as prune juice in this test), thus improving the sugar reduction effect of fruit juice.

In a fourth aspect, the effect of recycling magnetic immobilized glucose oxidase (0.1%) and magnetic immobilized catalase (1%) on reducing sugar in prune juice was tested. The test results are shown in Table 6 below.

TABLE 6

| Number of | Glucose reduction | Total sugar reduction |
|---|---|---|
| recycle | rate (%) | rate (%) |
| 30 | 64.01 | 34.92 |
| 60 | 63.99 | 34.91 |
| 90 | 63.99 | 34.90 |
| 120 | 62.74 | 34.87 |

It can be seen from Table 6 that when reducing sugar in fruit juice (such as prune juice in this test) by using magnetic immobilized enzyme, the magnetic immobilized enzyme can be reused, and the total sugar reduction rate of fruit juice after being reused for 120 times is very close to that after being reused for 30 times, which indicates that the magnetic immobilized enzyme in the present application has a high reuse rate.

In a fifth aspect, the sugar-reduced litchi juice was prepared by the equipment/method for reducing sugar in fruit juice provided by the present application, and the anti-aging effect of the sugar-reduced litchi juice was tested from two aspects, one of which was the β-galactosidase staining intensity and the other was the ROS fluorescence intensity.

For the ROS fluorescence intensity, wild-type AB strain zebrafish at 6 hpf (6-hour post fertilization) were randomly selected and placed in 6-well plates, with 30 zebrafish per well. The sugar-reduced litchi juice was dissolved in water to obtain a sugar-reduced litchi juice group, and a normal control group and a model control group were set up. Each well of the 6-well plate had a volume of 3 mL. Except for the normal control group, all other groups were given 1000 μM hydrogen peroxide to establish a zebrafish aging model, and the medium was changed daily during the experiment. After 6 days of treatment at 28° C., the zebrafish in each experimental group were transferred to a black 96-well microplate, with 2 fish per well, each well having a volume of 100 μL. A multifunctional microplate reader was used to analyze the ROS fluorescence intensity of zebrafish in each experimental group, and the anti-aging effect of sugar-reduced litchi juice was evaluated by the statistical analysis results of this indicator.

For the β-galactosidase staining intensity, wild-type AB strain zebrafish at 6 hpf (6-hour post fertilization) were randomly selected and placed in 6-well plates, with 30 zebrafish per well. The sugar-reduced litchi juice was dissolved in water to obtain a sugar-reduced litchi juice group, and a normal control group and a model control group were set up. Each well of the 6-well plate had a volume of 3 mL. Except for the normal control group, all other groups were given 1000 μM hydrogen peroxide to establish a zebrafish aging model, and the medium was changed daily during the experiment. After 6 days of treatment at 28° C., the zebrafish in each experimental group were stained using a cellular senescence β-galactosidase staining kit. After staining, 10 zebrafish were randomly selected from each experimental group to be photographed under a dissecting microscope, and the data were collected using Advanced Image Processing Software NIS-Elements D3.20 to analyze the β-galactosidase staining intensity in the zebrafish, and the anti-aging effect of sugar-reduced litchi juice was evaluated by the statistical analysis results of this indicator.

The anti-aging effect of sugar-reduced litchi juice is shown in Table 7 below.

TABLE 7

| | Normal | Model | Sugar-reduced |
|---|---|---|---|
| | control | control | litchi juice |
| Evaluation indicators | group | group | (1.95 μL/mL) |
| ROS fluorescence value | 1830 | 2537 | 885 |
| β-galactosidase staining | 47089 | 57276 | 48272 |
| intensity (pixel) | | | |

It can be seen from Table 7 that the sugar-reduced litchi juice prepared by the equipment/method for reducing sugar in fruit juice provided by the present application can exert an anti-aging effect to a certain extent.

In a sixth aspect, the sugar-reduced Rosa Roxburghii juice was prepared by the equipment/method for reducing sugar in fruit juice provided by the present application, and the anti-radiation effect of the sugar-reduced Rosa Roxburghii juice was tested in three aspects, which respectively are the scavenging ability of the sugar-reduced Rosa Roxburghii juice on DPPH free radicals, ABTS free radicals and hydroxyl free radicals; the effect of sugar-reduced Rosa Roxburghii juice on the viability of hepatocyte HL-7702 cells; and the anti-radiation effect of sugar-reduced Rosa Roxburghii juice on mice.

To test the scavenging ability of sugar-reduced Rosa Roxburghii juice on DPPH free radicals, ABTS free radicals and hydroxyl free radicals, the experimental method is as follows. The sugar-reduced Rosa Roxburghii juice was diluted by a certain multiple, and it was mixed with DPPH ethanol solution, ABTS solution and sample solution containing hydroxyl free radicals respectively. After standing for a certain period of time, the mixture was measured with an ultraviolet-visible spectrophotometer. The test results are shown in FIG. 6; in which, (a) in FIG. 6 is the test result of sugar-reduced Rosa Roxburghii juice for scavenging DPPH free radicals, (b) in FIG. 6 is the test result of sugar-reduced Rosa Roxburghii juice for scavenging ABTS free radicals, and (c) in FIG. 6 is the test result of sugar-reduced Rosa Roxburghii juice for scavenging hydroxyl free radicals.

It can be known from (a) in FIG. 6 that after the sugar-reduced Rosa Roxburghii juice prepared in the present application is diluted 100 times, the scavenging rate of DPPH free radicals can reach 92.35%, and after diluted 4 times, the scavenging rate of DPPH free radicals can still reach 77.42%, that is, it still has a high ability to scavenge DPPH free radicals after diluted 4 times. It can be known from (b) in FIG. 6 that after the sugar-reduced Rosa Roxburghii juice prepared in the present application is diluted 1100 times, the scavenging rate of ABTS free radicals can reach 42.15%. It can be known from (c) in FIG. 6 that after the sugar-reduced Rosa Roxburghii juice prepared in the present application is diluted 40 times, the scavenging rate of hydroxyl free radicals can reach 98.93%. That is to say, the sugar-reduced Rosa Roxburghii juice prepared in the present application retains most of the nutritional components in the original Rosa Roxburghii juice, and each component has high activity and good scavenging effect on DPPH free radicals, ABTS free radicals and hydroxyl free radicals.

To test the effect of sugar-reduced Rosa Roxburghii juice on the cell viability of hepatocyte HL-7702, it involves the toxicity test of sugar-reduced Rosa Roxburghii juice on the cell viability and the test of the improvement of sugar-reduced Rosa Roxburghii juice on the cell viability of HL-7702 after anti-radiation.

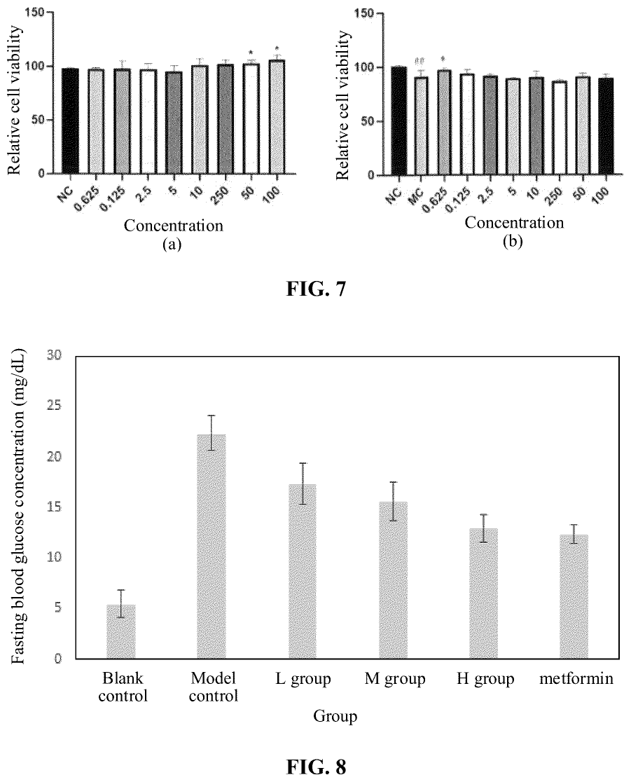

To test the toxicity of sugar-reduced Rosa Roxburghii juice on cell viability, the experiment is carried out as follows. HL-7702 cells with 3-6 passages were used, and when the cells grow to the optimal period, the cells were digested, resuspended, and diluted and counted. The cell concentration was adjusted to 5.5×10³ cells/mL to 6.5×10³ cells/mL, and the cell suspension was added into 96-well plates with a volume of 90 μL per well, approximately 5000 cells per well. Test wells with different concentrations of sugar-reduced Rosa Roxburghii juice, negative control wells, and zero-adjustment wells (only culture medium, serum, and CCK8, where CCK8 is a widely used reagent in cell viability testing) were set up. The cells were cultured under conditions of 5% CO₂ at 37° C., and the cells were cultured overnight and adhered to the wall, and then added at 5 to 7 concentration gradients and cultured for 24 hours. After cell culture, the supernatant was carefully aspirated, and 100 μL of fresh culture medium and 10 μL of CCK8 solution were added, and then cultured for an additional 2 hours. The absorbance of each well was measured at 450 nm using a microplate instrument. The test results are shown in FIG. 7(a).

To test the improvement effect of sugar-reduced Rosa Roxburghii juice on the viability of HL-7702 cells after anti-radiation, the experiment is carried out as follows. HL-7702 cells 3-6 passages were used, and when the cells grow to the optimal period, the cells were digested, resuspended, and diluted and counted. The cell concentration was adjusted to 5.5×10³ cells/mL to 6.5×10³ cells/mL, and the cell suspension was added into 96-well plates with a volume of 90 μL per well, approximately 5000 cells per well. A blank control group (NC), an irradiated control group (IR group), a sample control group, and a sample irradiated group (added with sugar-reduced Rosa Roxburghii juice) were set up. The cells were cultured under conditions of 5% CO₂ at 37° C., and the cells were cultured overnight and adhered to the wall, and then added at 5 to 7 concentration gradients. After 12 hours, AML-12 cells were treated with ⁶⁰Coγ radiation, with the radiation dose rate of 2 Gy/min and the total dose of 6 Gy, and the cells were then cultured for an additional 24 hours. After cell culture, the supernatant was carefully aspirated, and 100 μL of fresh culture medium and 10 μL of CCK8 solution were added, and cultured for an additional 2 hours. The absorbance of each well was measured at 450 nm using a microplate reader. The test results are shown in FIG. 7(b).

It can be known from (a) in FIG. 7 that when the sugar-reduced Rosa Roxburghii juice is at the dosage of 0.625 μL/mL to 100 μL/mL, it has no toxic effect on HL-7702 cells, and when the sugar-reduced Rosa Roxburghii juice is at the dosage of 50 μL/mL to 100 μL/mL, it has proliferative effect on HL-7702 cells. It can be known from (b) in FIG. 7 that the cell viability of HL-7702 decreases after ⁶⁰Coγ radiation, and the sugar-reduced Rosa Roxburghii juice can improve the decrease in the cell viability of HL-7702 after ⁶⁰Coγ radiation, especially when the dose is 0.625 μL/mL to 2.5 μL/mL, the improvement effect of the sugar-reduced Rosa Roxburghii juice on the decrease in the cell viability is the most obvious.

To test the anti-radiation effects of sugar-reduced Rosa Roxburghii juice on mice, 144 male Kunming mice were selected, each weighing 18 g to 20 g and aged 6 to 8 weeks. The environmental temperature was set at (24±2° C.), and the relative humidity was set at 40% to 60%. The mice had free access to food and water. After 3 days of adaptive feeding, the formal experiment began. The mice were randomly divided into 12 groups, with 12 mice in each group. The grouping is as follows: a normal control group (NC) and a radiation model group (MC) were gavaged with normal saline; the sugar-reduced Rosa Roxburghii juice was divided into three groups: low-dose, medium-dose and high-dose. The mice in the low-dose sugar-reduced Rosa Roxburghii juice group were gavaged with 5 mL/kg per day, the mice in the medium-dose sugar-reduced Rosa Roxburghii juice group were gavaged with 10 mL/kg per day, and the mice in the high-dose sugar-reduced Rosa Roxburghii juice group were given 15 mL/kg per day by gavage. After 30 days, each group (except the normal control group) was given a one-time whole-body uniform radiation treatment with ⁶⁰Co rays, with a total radiation dose of 6.0 Gy of ⁶⁰Co rays and a dose rate of 2.0 Gy/min. After the irradiation treatment, the mice were fasted but allowed free access to water. After 24 hours, the mice were processed and indicators were measured. The results are shown in Tables 8 to 14. Table 8 shows the effects of sugar-reduced Rosa Roxburghii juice on the spleen of irradiated mice. Table 9 shows the effects of sugar-reduced Rosa Roxburghii juice on peripheral hemogram of irradiated mice. Table 10 shows the effects of sugar-reduced Rosa Roxburghii juice on bone marrow DNA of irradiated mice. Table 11 shows the effects of sugar-reduced Rosa Roxburghii juice on SOD activity in the bodies of irradiated mice. Table 12 shows the effects of sugar-reduced Rosa Roxburghii juice on MDA levels in the bodies of irradiated mice. Table 13 shows the effects of sugar-reduced Rosa Roxburghii juice on the serum GSH levels in irradiated mice. Table 14 shows the effects of sugar-reduced Rosa Roxburghii juice on the levels of ALT and AST in the serum of irradiated mice.

TABLE 8

| | | | Low dose of | Medium dose | High dose of |
|---|---|---|---|---|---|
| | | | sugar-reduced | of sugar-reduced | sugar-reduced |
| | Normal control | Radiation | Rosa Roxburghii | Rosa Roxburghii | Rosa Roxburghii |
| | group | model group | juice group | juice group | juice group |
| Spleen index | 0.28 ± 0.02 | 0.12 ± 0.01 | 0.17 ± 0.005 | 0.19 ± 0.01 | 0.18 ± 0.01 |
| (%) | | | | | |

As can be seen from Table 8, radiation treatment has seriously damaged the spleen organs of mice, but the sugar-reduced Rosa Roxburghii juice prepared in the present application has an obvious recovery effect on the spleen of irradiated mice.

TABLE 9

| | | | Low dose of | Medium dose | High dose of |
|---|---|---|---|---|---|
| | | | sugar-reduced | of sugar-reduced | sugar-reduced |
| | Normal control | Radiation | Rosa Roxburghii | Rosa Roxburghii | Rosa Roxburghii |
| | group | model group | juice group | juice group | juice group |
| Number of | 4.8 ± 1.11 | 1.31 ± 0.34 | 1.77 ± 0.65 | 1.42 ± 0.36 | 1.82 ± 0.53 |
| white blood | | | | | |
| cells (10⁹/L) | | | | | |
| Red blood | 10.89 ± 0.62 | 9.61 ± 0.47 | 10.91 ± 0.33 | 10.93 ± 0.35 | 10.72 ± 0.55 |
| cells | | | | | |
| (10¹²/L) | | | | | |
| Hemoglobins | 163 ± 23 | 146 ± 12 | 160 ± 8 | 161 ± 15 | 152 ± 12 |
| (g/L) | | | | | |
| Platelets | 1136 ± 114 | 864 ± 42 | 1105 ± 110 | 1106 ± 114 | 998 ± 121 |
| (10⁹/L) | | | | | |

As can be seen from Table 9, ionizing radiation has seriously damaged the hematopoietic system of mice, and different concentrations of sugar-reduced Rosa Roxburghii juice can alleviate such damage, especially for red blood cells, hemoglobins and platelets.

TABLE 10

| | | | Low dose of | Medium dose of | High dose of |
|---|---|---|---|---|---|
| | | | sugar-reduced | sugar-reduced | sugar-reduced |
| | Normal control | Radiation | Rosa Roxburghii | Rosa Roxburghii | Rosa Roxburghii |
| | group | model group | juice group | juice group | juice group |
| OD260 | 0.91 ± 0.04 | 0.23 ± 0.05 | 0.47 ± 0.01 | 0.38 ± 0.08 | 0.45 ± 0.03 |

As can be seen from Table 10, irradiation can reduce the bone marrow DNA content in mice, but the sugar-reduced Rosa Roxburghii juice prepared in the present application has an obvious alleviating effect on this.

TABLE 11

| | | | Low dose of | Medium dose | High dose of |
|---|---|---|---|---|---|
| | | | sugar-reduced | of sugar-reduced | sugar-reduced |
| | Normal control | Radiation | Rosa Roxburghii | Rosa Roxburghii | Rosa Roxburghii |
| | group | model group | juice group | juice group | juice group |
| Serum | 46.27 ± 2.35 | 36.83 ± 1.97 | 46.21 ± 2.27 | 49.13 ± 2.01 | 47.28 ± 3.35 |
| (U/mL) | | | | | |
| Liver (U/ | 85.03 ± 8.9 | 62.52 ± 7.68 | 68.13 ± 8.71 | 70.35 ± 9.83 | 69.37 ± 8.29 |
| mgprot) | | | | | |
| Spleen (U/ | 28.08 ± 1.95 | 23.56 ± 2.33 | 24.88 ± 1.05 | 28.01 ± 2.67 | 28.39 ± 3.15 |
| mgprot) | | | | | |

As can be seen from Table 11, irradiation can reduce the activity of antioxidant enzyme SOD in mice, but the sugar-reduced Rosa Roxburghii juice prepared in the present application can enhance the activity of antioxidant enzyme SOD in irradiated mice, thus preventing oxidative damage caused by ionizing radiation to mice to a certain extent.

TABLE 12

| | | | Low dose of | Medium dose | High dose of |
|---|---|---|---|---|---|
| | | | sugar-reduced | of sugar-reduced | sugar-reduced |
| | Normal control | Radiation | Rosa Roxburghii | Rosa Roxburghii | Rosa Roxburghii |
| | group | model group | juice group | juice group | juice group |
| Serum | 15.89 ± 1.57 | 17.75 ± 1.66 | 13.24 ± 1.98 | 14.93 ± 1.71 | 14.12 ± 1.02 |
| (nmol/mL) | | | | | |
| Liver (nmol/ | 1.27 ± 0.35 | 1.98 ± 0.31 | 1.46 ± 0.21 | 1.31 ± 0.18 | 1.13 ± 0.20 |
| mgprot) | | | | | |
| Spleen (nmol/ | 0.75 ± 0.08 | 1.26 ± 0.21 | 0.86 ± 0.09 | 1.23 ± 0.18 | 1.25 ± 0.08 |
| mgprot) | | | | | |

As can be seen from Table 12, irradiation increases the content of MDA in the liver of mice, but the sugar-reduced Rosa Roxburghii juice prepared in the present application can significantly reduce the content of MDA in the liver of irradiated mice, thus alleviating the damage of lipid peroxidation in the spleen of mice after irradiation to a certain extent.

TABLE 13

| | | | Low dose of | Medium dose | High dose of |
|---|---|---|---|---|---|
| | | | sugar-reduced | of sugar-reduced | sugar-reduced |
| | Normal control | Radiation | Rosa Roxburghii | Rosa Roxburghii | Rosa Roxburghii |
| | group | model group | juice group | juice group | juice group |
| Serum (μmol/ | 55.76 ± 4.03 | 42.04 ± 8.41 | 60.08 ± 8.77 | 50.16 ± 3.89 | 46.75 ± 8.63 |
| mL) | | | | | |
| Liver (μmol/ | 4.17 ± 0.84 | 3.07 ± 0.67 | 3.58 ± 0.65 | 4.12 ± 0.71 | 3.37 ± 0.69 |
| mgprot) | | | | | |
| Spleen (μmol/ | 11.71 ± 2.47 | 5.69 ± 1.13 | 7.37 ± 1.56 | 8.12 ± 0.37 | 8.43 ± 1.38 |
| mgprot) | | | | | |

As can be seen from Table 13, the sugar-reduced Rosa Roxburghii juice prepared in the present application can improve the serum GSH level of mice and has a certain protective effect on irradiation.

TABLE 14

| | | | Low dose of | Medium dose of | High dose of |
|---|---|---|---|---|---|
| | | | sugar-reduced | sugar-reduced | sugar-reduced |
| | Normal control | Radiation | Rosa Roxburghii | Rosa Roxburghii | Rosa Roxburghii |
| | group | model group | juice group | juice group | juice group |
| ALT(U/L) in | 9.37 ± 0.66 | 12.96 ± 1.57 | 7.44 ± 0.61 | 7.58 ± 0.97 | 5.32 ± 1.79 |
| serum | | | | | |
| AST(U/L) in | 14.78 ± 1.39 | 17.34 ± 1.81 | 15.29 ± 1.44 | 15.38 ± 1.56 | 13.84 ± 1.99 |
| serum | | | | | |

As can be seen from Table 14, irradiation will cause damage to the liver of mice, but the sugar-reduced Rosa Roxburghii juice prepared in the present application can repair the liver injury caused by irradiation to some extent.

In a seventh aspect, the sugar-reduced prune juice was prepared by the equipment/method for reducing sugar in fruit juice provided in the present application, and the blood glucose reduction efficacy of the sugar-reduced prune juice was tested. The testing process is as follows.

60 healthy male C57BL/6J mice were selected. The mice were reared at a temperature of (23±2° C.), with a relative humidity of 50% to 60%, and a 12 h light/dark alternating cycle. The mice were allowed free access to food and water. Eight mice were randomly selected as the blank control group, and the other 50 mice were used as the model group. Each mouse was intraperitoneally injected with 60 mg/kg streptozotocin and at the same time they were fed with high-fat feed continuously to induce the establishment of T2DM mouse model. After 72 h, when the fasting blood glucose level of mice was greater than 11.1 mmol/L, the model was considered to be successfully established. Excluding unqualified and dead mice, a total of 40 mice were successfully modeled and divided into five groups with eight mice in each group: the model control group, the low-dose group (group L), the medium-dose group (group M), the high-dose group (group H) and the positive control group (metformin). Among them, the blank control group was gavaged with 100 mg/kg normal saline, the model control group was gavaged with 100 mg/kg normal saline, the group L was gavaged with 150 mg/kg sugar-reduced prune juice, the group M was gavaged with 300 mg/kg sugar-reduced prune juice, the group H was gavaged with 600 mg/kg sugar-reduced prune juice, and the positive control group was gavaged with 60 mg/kg metformin. During the experiment, the fasting blood glucose levels were measured weekly, and the gavage was continued for four weeks.

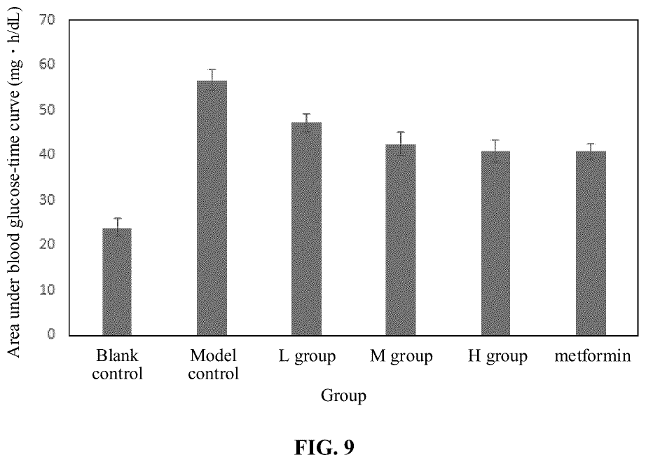

The mice were fed for four weeks, and they were fasted but were allowed free access to water one day before the end of the experiment. After 16 h of overnight fasting, blood was collected from the tail vein to measure the blood glucose content (0 min value). Each mouse was intraperitoneally injected with 2.0 g/kg glucose, and the blood glucose contents were measured at 0, 0.5, 1.0, 1.5, and 3.0 h after glucose administration with a blood glucose meter. The area under the blood glucose-time curve (AUC) was calculated. The measured results are shown in FIG. 8 and FIG. 9.

It can be seen from FIG. 8 that the fasting blood glucose concentration of the model control group is higher than that of the blank control group, indicating that the model was successfully established. After gavage with sugar-reduced prune juice and metformin, the blood glucose concentrations of the experimental group and the metformin group both decreased, and the data of the high dose group are close to those of the metformin group, indicating that sugar-reduced prune juice has the effect of inhibiting the increase in blood glucose. However, the blood glucose data of the metformin group are still higher than those of the blank control group, probably because the pancreatic islet cells of the model mice were irreversibly damaged during the model establishment, making it impossible to restore the blood glucose to the initial normal level. It can be seen from FIG. 9 that compared with the blank control group, the AUC of the model control group was significantly increased, indicating that its tolerance was significantly reduced. Compared with the model control group, the AUC of the high dose, the medium dose, and the low dose groups of sugar-reduced prune juice and the metformin group all showed a downward trend, indicating that sugar-reduced prune juice can improve the glucose tolerance of mice. It can be seen that the sugar-reduced prune juice prepared in the present application has excellent effects of improving glucose tolerance and reducing blood glucose in mice.

The above examples are only preferred embodiments of the present application and they are not the only limitations on the equipment for reducing sugar in fruit juice, the method for reducing sugar in fruit juice, and related content. In view of this, those skilled in the art can make flexible settings according to actual application scenarios on the basis of the above examples. It can be understood that, through implementing the above embodiments of the present application, fruit juice and magnetic immobilized enzymes are introduced into the fermentation tank 300, and the magnetic field generating device is controlled not to generate a magnetic field which penetrates into the fermentation tank 300, so that the magnetic immobilized enzyme in the fermentation tank 300 is dispersed in the fruit juice. The magnetic immobilized enzyme dispersed in the fruit juice will undergo enzymolysis reaction, that is, the sugars in the fruit juice are decomposed into other substances, thereby achieving sugar reduction in the fruit juice. As time passes, after the enzymolysis reaction is completed, the magnetic field generating device can be controlled to generate a magnetic field which penetrates into the fermentation tank 300, so that the magnetic immobilized enzyme in the fermentation tank 300 can be adsorbed on the inner wall of the fermentation tank 300 by the magnetic field generating device, and the fruit juice in the fermentation tank 300 can then be discharged to obtain the sugar-reduced fruit juice. During the process of discharging the fruit juice, the magnetic field generating device will keep adsorbing the magnetic immobilized enzymes onto the inner wall of the fermentation tank 300, so the magnetic immobilized enzymes in the fermentation tank 300 will not be discharged from the fermentation tank 300 together with the fruit juice. That is to say, in the present application, the magnetic immobilized enzyme is used to reduce the sugar in the fruit juice, and it is not necessary to use high temperature to inactivate free enzymes as in traditional solutions, so that the sugar reduction process of the fruit juice is simplified, the sugar reduction efficiency is improved, and the nutritional components in the fruit juice and the flavor and color of the fruit juice can be better retained. In the application, when the fruit juice is discharged from the fermentation tank 300, the magnetic field generating device is used to adsorb the magnetic immobilized enzyme to separate the magnetic immobilized enzyme from the fruit juice. Unlike traditional solutions that rely on centrifugation or filtration for separation, this method enables faster separation of the magnetic immobilized enzyme from the fruit juice. It can also prevent insoluble substances in the fruit juice from adhering to the immobilized enzymes, thereby improving the reuse rate of the immobilized enzyme. Therefore, the sugar-reduced fruit juice produced by the present application has higher nutritional components and good flavor and color, and can be well applied in maintaining body shape and/or products for preventing diseases.

It should be noted that above several embodiments shown in the present application are described in a progressive manner, and each of embodiments focuses on the differences from other embodiments, and references may be made among these embodiments with respect to the same or similar portions. It should also be noted that in the text description of the present application, the relationship terms “first”, “second” and the like are only used to distinguish one entity or operation from another, rather than to necessitate or imply that an actual relationship or order exists between the entities or operations. Further, the terms “including”, “comprising” or any other corresponding variant are intended to cover non-exclusive inclusion, so that a process, method, article or equipment including a series of elements not only includes these elements, but also includes other elements not explicitly listed, or may also include elements inherent to such process, method, article or equipment. Moreover, without more restrictions, the element defined by the sentence “including a . . . ” does not exclude that there are other identical elements in the process, method, article or equipment including the element.

In addition, by implementing above several embodiments shown in the present application, those skilled in the art can realize or use the present application. Many modifications will be obvious to those skilled in the art for above several embodiments shown in the present application, and the general principles defined in the present application can be realized in other embodiments not shown without departing from the spirit or scope of the present application. Therefore, the present application will not be limited to the above several embodiments shown in the foregoing, but is to be accorded the widest scope consistent with the principles and novel features disclosed in the present application.

1. An equipment for reducing sugar in fruit juice, comprising a frame, a magnetic field generating device and a hollow fermentation tank, wherein the magnetic field generating device and the fermentation tank are arranged on the frame and spaced apart from each other, and the fermentation tank is provided with a liquid inlet and a liquid outlet communicated with an inside of the fermentation tank, wherein:
the liquid inlet is configured to introduce the fruit juice and a magnetic immobilized enzyme into the fermentation tank to reduce sugar in the fruit juice by utilizing an enzymolysis reaction of the magnetic immobilized enzyme in the fruit juice;
the magnetic field generating device is configured to generate a magnetic field which penetrates into the fermentation tank after the enzymolysis reaction is completed to adsorb the magnetic immobilized enzyme onto the inner wall of the fermentation tank; and
the liquid outlet is configured to discharge the fruit juice in the fermentation tank after the magnetic field generating device adsorbs the magnetic immobilized enzyme onto the inner wall of the fermentation tank.

2. The equipment for reducing sugar in fruit juice according to claim 1, further comprising a controller arranged on the frame and communicatively connected to the magnetic field generating device, wherein the controller is configured to control the magnetic field generating device to generate a magnetic field which penetrates into the fermentation tank after the enzymolysis reaction is completed; or
wherein the fermentation tank is provided with an upper end and a lower end that are opposite to each other, the liquid inlet is located at the upper end, the liquid outlet is located at the lower end, and the position of the liquid outlet is lower than that of the magnetic field generating device.

3. The equipment for reducing sugar in fruit juice according to claim 2, wherein the magnetic field generating device comprises an electromagnetic device and a power supply arranged on the frame, the electromagnetic device is spaced apart from the fermentation tank and electrically connected to the power supply, the power supply is communicatively connected to the controller, and the controller is specifically configured to control the power supply to power the electromagnetic device after the enzymolysis reaction is completed, so that the electromagnetic device generates a magnetic field which penetrates into the fermentation tank; or
wherein the magnetic field generating device comprises a magnetic attraction device, a lifting device and a magnetic shielding plate, the magnetic attraction device is arranged on the frame and spaced apart from the fermentation tank, the lifting device is arranged on the frame and located between the magnetic attraction device and the fermentation tank, the magnetic shielding plate is arranged on the lifting device and drivingly connected to the lifting device, the lifting device is communicatively connected to the controller, and the controller is specifically configured to control the lifting device to drive the magnetic shielding plate to rise between the magnetic attraction device and the fermentation tank before the enzymolysis reaction starts, so as to prevent the magnetic field generated by the magnetic attraction device from penetrating into the fermentation tank, so that the magnetic immobilized enzyme is dispersed in the fruit juice; to control the lifting device to drive the magnetic shielding plate to withdraw from between the magnetic attraction device and the fermentation tank after the enzymolysis reaction is completed, so that the magnetic field generated by the magnetic attraction device penetrates into the fermentation tank; or
wherein the equipment for reducing sugar in fruit juice further comprises a stirring device arranged on the inner wall of the fermentation tank and communicatively connected to the controller, wherein the controller is further configured to control the stirring device to stir the fruit juice before the enzymolysis reaction is completed; or
wherein the equipment for reducing sugar in fruit juice further comprises a pressure detector, an electric actuator and an exhaust valve, wherein the fermentation tank is further provided with an exhaust port communicated with the inside of the fermentation tank, the exhaust valve is arranged in the exhaust port, the electric actuator is arranged on the exhaust valve and drivingly connected to the exhaust valve, the pressure detector is arranged on the inner wall of the fermentation tank, and the pressure detector and the electric actuator are communicatively connected to the controller respectively, wherein:
the electric actuator is configured to open or close the exhaust valve;
the pressure detector is configured to detect the pressure in the fermentation tank in real time and transmit the pressure in the fermentation tank to the controller before the enzymolysis reaction is completed; and
the controller is further configured to judge whether the pressure in the fermentation tank exceeds a preset safe pressure range, and when the pressure exceeds the safe pressure range, to control the electric actuator to open the exhaust valve to exhaust the gas in the fermentation tank, so that the pressure in the fermentation tank returns to the safe pressure range; and to control the electric actuator to close the exhaust valve after the pressure in the fermentation tank returns to the safe pressure range.

4. The equipment for reducing sugar in fruit juice according to claim 3, wherein the electromagnetic device comprises an annular electromagnet surrounding the fermentation tank; or,
the electromagnetic device comprises at least one electromagnet; wherein, when the electromagnetic device comprises two electromagnets, the two electromagnets are located on two opposite sides of the fermentation tank respectively; and when the electromagnetic device comprises more than two electromagnets, the plurality of electromagnets are arranged around the fermentation tank and any two adjacent electromagnets are spaced apart from each other.

5. The equipment for reducing sugar in fruit juice according to claim 3, wherein the magnetic attraction device comprises an annular magnet surrounding the fermentation tank; or,
the magnetic attraction device comprises at least one magnet; wherein, when the magnetic attraction device comprises the two magnets, the two magnets are located on two opposite sides of the fermentation tank respectively; and when the magnetic attraction device comprises more than two magnets, the plurality of magnets are arranged around the fermentation tank and any two adjacent magnets are spaced apart from each other.

6. The equipment for reducing sugar in fruit juice according to claim 2, further comprising a temperature detector and a heating device which are communicatively connected to the controller respectively, wherein the heating device is arranged on the frame and is in contact with the outer wall of the fermentation tank, and the temperature detector is arranged on the inner wall of the fermentation tank and configured to be immersed in the fruit juice, wherein:
the heating device is configured to heat the fruit juice before the enzymolysis reaction is completed;
the temperature detector is configured to detect the temperature of the fruit juice in real time and transmit the temperature of the fruit juice to the controller before the enzymolysis reaction is completed; and
the controller is further configured to judge whether the temperature of the fruit juice is within a preset temperature range, and if not, to control the heating device to adjust the heating amount for heating the fruit juice, so that the temperature of the fruit juice is within the preset temperature range.

7. The equipment for reducing sugar in fruit juice according to claim 6, wherein the heating device comprises a heating jacket and a power source communicatively connected to the controller, the heating jacket is sleeved on the outer wall of the fermentation tank, and the power source is arranged on the frame and electrically connected to the heating jacket, wherein:
the power source is configured to deliver a heating current to the heating jacket to heat the heating jacket;
the heating jacket is configured to heat the fruit juice through the heat emitted by itself; and
the controller is specifically configured to control the power source to adjust the magnitude of the heating current when the temperature of the fruit juice is not within the preset temperature range, so as to adjust the heating amount of the heating jacket for heating the fruit juice, so that the temperature of the fruit juice is within the preset temperature range.

8. The equipment for reducing sugar in fruit juice according to claim 7, wherein the heating jacket comprises a heating element, a connecting terminal, an insulating layer and an inner layer and an outer layer that are opposite to each other, the inner layer is configured to contact with the outer wall of the fermentation tank, the insulating layer is arranged between the inner layer and the outer layer, the heating element is arranged between the insulating layer and the inner layer, the connecting terminal is arranged on the outer layer, and the heating element is electrically connected to the power source through the connecting terminal, wherein:
the connecting terminal is configured to deliver the heating current provided by the power source to the heating element to heat the heating element; and
the heating element is configured to heat the fruit juice through the heat emitted by itself.

9. The equipment for reducing sugar in fruit juice according to claim 6, wherein the heating device comprises a water storage jacket and a circulating water heating assembly, the water storage jacket is sleeved on the outer wall of the fermentation tank, the circulating water heating assembly is arranged on the frame and connected to the water storage jacket, and the circulating water heating assembly is communicatively connected to the controller, wherein:
the circulating water heating assembly is configured to circulate heating water into the water storage jacket and recycle the heating water in the water storage jacket, to heat the water storage jacket;
the water storage jacket is configured to heat the fruit juice through the heat emitted by itself; and
the controller is specifically configured to control the circulating water heating assembly to adjust the temperature of the heating water when the temperature of the fruit juice is not within the preset temperature range, so as to adjust the heating amount of the water storage jacket for heating the fruit juice, so that the temperature of the fruit juice is within the preset temperature range.

10. The equipment for reducing sugar in fruit juice according to claim 9, wherein the circulating water heating assembly comprises a heater, a water tank, a circulating water pump, a water inlet pipe and a water return pipe, the heater, the water tank and the circulating water pump are all arranged on the frame, the heater is in contact with the outer wall of the water tank, one end of the water inlet pipe is arranged in the water storage jacket, and the opposite end is communicated with the water tank through the circulating water pump, one end of the water return pipe is arranged in the water storage jacket, and the opposite end is communicated with the water tank through the circulating water pump, and the heater and the circulating water pump are communicatively connected to the controller respectively, wherein:
the heater is configured to heat the heating water stored in the water tank;
the circulating water pump is configured to circulate the heating water in the water tank into the water storage jacket through the water inlet pipe under the control of the controller, and to recycle the heating water in the water storage jacket into the water tank through the water return pipe, to heat the water storage jacket; and
the controller is specifically configured to control the heater to adjust the heating amount for heating the heating water when the temperature of the fruit juice is not within the preset temperature range, so as to adjust the heating amount of the water storage jacket for heating the fruit juice, so that the temperature of the fruit juice is within the preset temperature range.

11. The equipment for reducing sugar in fruit juice according to claim 2, further comprising a dissolved oxygen detector, a compressed air device and an air delivery pipe, wherein the dissolved oxygen detector and the compressed air device are communicatively connected to the controller respectively, the compressed air device is arranged on the frame, the dissolved oxygen detector is arranged on the inner wall of the fermentation tank and configured to be immersed in the fruit juice, the air delivery pipe is provided with an air inlet end and an air outlet end that are opposite to each other, the air inlet end is connected to the compressed air device, and the air outlet end is arranged in the fermentation tank and configured to be inserted into the fruit juice, wherein:
the compressed air device is configured to generate normal-temperature compressed air and deliver the normal-temperature compressed air to the fruit juice through the gas delivery pipe before the enzymolysis reaction is completed;
the dissolved oxygen detector is configured to detect dissolved oxygen of the fruit juice in real time and transmit the dissolved oxygen of the fruit juice to the controller before the enzymolysis reaction is completed; and
the controller is further configured to judge whether the dissolved oxygen of the fruit juice is within the preset dissolved oxygen range, and if not, to control the compressed air device to adjust the delivery amount of the normal-temperature compressed air to the fruit juice, so as to adjust the dissolved oxygen of the fruit juice, so that the dissolved oxygen of the fruit juice is within the preset dissolved oxygen range.

12. The equipment for reducing sugar in fruit juice according to claim 11, wherein the compressed air device comprises a driving motor, a compressor, an air filter element, a cooler and an air storage tank which are arranged on the frame, wherein the air filter element, the compressor, the cooler and the air storage tank are connected in sequence, the air storage tank is connected to the air inlet end through a flow control valve, the driving motor is drivingly connected to the compressor, and the driving motor and the flow control valve are communicatively connected to the controller respectively, wherein:
the driving motor is configured to drive the compressor under the control of the controller;
the air filter element is configured to filter the air entering the compressor;
the compressor is configured to compress the air and correspondingly obtain a high-temperature compressed air;
the cooler is configured to cool the high-temperature compressed air and correspondingly obtain a normal-temperature compressed air;
the air storage tank is configured to store the normal-temperature compressed air;
the flow control valve is configured to deliver the normal-temperature compressed air in the gas storage tank to the fruit juice through the gas delivery pipe; and
the controller is specifically configured to control the flow control valve to adjust its opening degree when the dissolved oxygen of the fruit juice is not within the preset dissolved oxygen range, so as to adjust the delivery amount of the normal-temperature compressed air to the fruit juice, so that the dissolved oxygen of the fruit juice is within the preset dissolved oxygen range.

13. The equipment for reducing sugar in fruit juice according to claim 2, further comprising a pH detector, a pH adjusting device and a liquid delivery tube, wherein the pH detector and the pH adjusting device are communicatively connected to the controller respectively, the pH adjusting device is arranged on the frame, the pH detector is arranged on the inner wall of the fermentation tank and configured to be immersed in the fruit juice; and the liquid delivery tube is provided with a liquid inlet end and a liquid outlet end that are opposite to each other, the liquid inlet end is connected to the pH adjusting device, and the liquid outlet end is arranged in the fermentation tank and configured to be inserted into the fruit juice, wherein:
the pH adjusting device is configured to inject an acidic solution and/or an alkaline solution into the fruit juice through the liquid delivery tube before the enzymolysis reaction is completed;
the pH detector is configured to detect the pH of the fruit juice in real time and transmit the pH of the fruit juice to the controller before the enzymolysis reaction is completed; and
the controller is further configured to judge whether the pH of the fruit juice is within a preset pH range, and if not, to control the pH adjusting device to adjust the injection amount of the acidic solution and/or the alkaline solution into the fruit juice, so that the pH of the fruit juice is within the preset pH range.

14. The equipment for reducing sugar in fruit juice according to claim 13, wherein the liquid delivery tube comprises an acidic liquid delivery tube and an alkaline liquid delivery tube, and the pH adjusting device comprises an acidic liquid storage tank, an alkaline liquid storage tank and a metering pump arranged on the frame, the metering pump is communicatively connected to the controller, the acidic liquid storage tank is configured to store the acidic solution, the alkaline liquid storage tank is configured to store the alkaline solution, a liquid outlet end of the acidic liquid delivery tube is arranged in the fermentation tank and configured to be inserted into the fruit juice, a liquid inlet end of the acidic liquid delivery tube is communicated with the acidic liquid storage tank through the metering pump, a liquid outlet end of the alkaline liquid delivery tube is arranged in the fermentation tank and configured to be inserted into the fruit juice, and a liquid inlet end of the alkaline liquid delivery tube is communicated with the alkaline liquid storage tank through the metering pump, wherein:
the metering pump is configured to pump the acidic solution from the acidic liquid storage tank and inject it into the fruit juice through the acidic liquid delivery pipe, and/or to pump the alkaline solution from the alkaline liquid storage tank and inject it into the fruit juice through the alkaline liquid delivery pipe; and
the controller is specifically configured to control the metering pump to adjust the pumping amount of the acidic solution and/or the alkaline solution when the pH of the fruit juice is not within the preset pH range, so as to adjust the injection amount of the acidic solution and/or the alkaline solution into the fruit juice, so that the pH of the fruit juice is within the preset pH range.

15. The equipment for reducing sugar in fruit juice according to claim 3, wherein the stirring device comprises a stirring blade and a stirring motor communicatively connected to the controller, the stirring motor is arranged on the inner wall of the fermentation tank and drivingly connected to the stirring blade, and the controller is specifically configured to control the stirring motor to drive the stirring blade to rotate before the enzymolysis reaction is completed, so as to stir the fruit juice through the rotation of the stirring blade.

16. A method for reducing sugar in fruit juice, comprising:
preparing a magnetic carrier;
immobilizing an enzyme on the magnetic carrier to obtain a magnetic immobilized enzyme; and
reducing sugar in fruit juice by an equipment for reducing sugar in fruit juice and the magnetic immobilized enzyme; wherein the equipment for reducing sugar in fruit juice is the equipment for reducing sugar in fruit juice according to claim 1.

17. The method for reducing sugar in fruit juice according to claim 16, wherein the step of preparing the magnetic carrier comprises:
dissolving ferric chloride hexahydrate and ferrous chloride tetrahydrate in water to obtain a first mixed solution;
adding chitosan into the first mixed solution, and stirring to obtain a second mixed solution;
adding sodium hydroxide solution into the second mixed solution, heating and stirring to obtain a third mixed solution, cooling the third mixed solution, and adjusting the pH of the third mixed solution;
adding glutaraldehyde solution into the third mixed solution, and heating and stirring to obtain a fourth mixed solution in which the magnetic carrier is dispersed; and
absorbing out the magnetic carrier in the fourth mixed solution with a magnet, and dispersing the magnetic carrier in a boric acid solution to obtain a magnetic carrier dispersion; or
wherein the step of reducing sugar in fruit juice by the equipment for reducing sugar in fruit juice and the magnetic immobilized enzyme comprises:
introducing the fruit juice and the magnetic immobilized enzyme into the fermentation tank through the liquid inlet, to reduce sugar in the fruit juice by utilizing the enzymolysis reaction of the magnetic immobilized enzyme in the fruit juice;
after the enzymolysis reaction is completed, the magnetic field generating device generating the magnetic field, which penetrates into the fermentation tank, to adsorb the magnetic immobilized enzyme on the inner wall of the fermentation tank; and
discharging the fruit juice in the fermentation tank through the liquid outlet.

18. The method for reducing sugar in fruit juice according to claim 17, wherein the step of immobilizing the enzyme on the magnetic carrier to obtain the magnetic immobilized enzyme comprises:
adding an enzyme solution into the magnetic carrier dispersion, and stirring to obtain a fifth mixed solution; and
adding glutaraldehyde solution into the fifth mixed solution, and heating and stirring to immobilize the enzyme in the enzyme solution on the magnetic carrier to form the magnetic immobilized enzyme.

19. A sugar-reduced fruit juice, wherein the sugar-reduced fruit juice is made by the equipment for reducing sugar in fruit juice according to claim 1.

20. A method for maintaining body shape and/or preventing diseases, comprising administering the sugar-reduced fruit juice according to claim 19 to a subject in need thereof.
